(19) United States
(12) Patent Application Publication
(10) Pub. No.: US 2023/0046946 A1
(43) Pub. Date: Feb. 16, 2023

(54) MERGE MODE, ADAPTIVE MOTION VECTOR PRECISION, AND TRANSFORM SKIP SYNTAX

(71) Applicant: InterDigital VC Holdings France, Cesson-Sevigne (FR)

(72) Inventors: Karam Naser, Cesson-Sevigne (FR); Antoine Robert, Mézières sur Couesnon (FR); Tangi Poirier, Thorigné-Fouillard (FR); Franck Galpin, Thorigne-Fouillard (FR)

(73) Assignee: InterDigital VC Holdings France, Cesson Sevigne (FR)

(21) Appl. No.: 17/790,055

(22) PCT Filed: Dec. 24, 2020
(86) PCT No.: PCT/EP2020/087882

§ 371 Date: Jun. 29, 2022

(30) Foreign Application Priority Data
Dec. 30, 2019 (EP) 19306787.3

(51) Int. Cl. H04N 19/513; H04N 19/44

(52) U.S. Cl. CPC H04N 19/513; H04N 19/44

(57) ABSTRACT

An apparatus (for example, a decoder) may determine that affine mode is enabled for a video sequence. The apparatus may determine whether an affine mode adaptive motion vector difference resolution (AMVR) enablement indicator is present in a parameter set associated with the video sequence based on a value of an AMVR enablement indicator. If the value of the AMVR enablement indicator indicates AMVR mode is enabled for the video sequence, the apparatus may determine that the affine mode AMVR enablement indicator is present in the parameter set associated with the video sequence. If the value of the AMVR enablement indicator indicates AMVR mode is disabled for the video sequence, the apparatus may determine that the affine mode AMVR enablement indicator is not present in the parameter set associated with the video sequence. The apparatus may decode the video sequence accordingly.

### CROSS REFERENCE TO RELATED APPLICATIONS

This application claims priority to EP Provisional Patent Application No. 19306787.3, filed on Dec. 30, 2019, and entitled “MERGE MODE, ADAPTIVE MOTION VECTOR PRECISION, AND TRANSFORM SKIP SYNTAX,” the entirety of which is incorporated by reference as if fully set forth herein.

### BACKGROUND

Video coding systems may be used to compress digital video signals, for example, to reduce the storage and/or transmission bandwidth needed for such signals. Video coding systems may include block-based, wavelet-based, and/or object-based systems. A block-based hybrid video coding system may be deployed.

### SUMMARY

Systems, methods, and instrumentalities are disclosed for adaptive motion vector resolution (AMVR). An apparatus (for example, a decoder) may determine that affine mode is enabled for a video sequence. The apparatus may determine whether an affine mode AMVR enablement indicator is present in a parameter set associated with the video sequence based on a value of an AMVR enablement indicator. The apparatus may decode the video sequence based on the determination of whether the affine mode AMVR enablement indicator is present in the parameter set associated with the video sequence. If the value of the AMVR enablement indicator indicates AMVR mode is enabled for the video sequence, the apparatus may determine that the affine mode AMVR enablement indicator is present in the parameter set associated with the video sequence. In examples, the apparatus may obtain the affine mode AMVR enablement indicator in response to a determination that the affine mode AMVR enablement indicator is present in the parameter set associated with the video sequence. If the value of the AMVR enablement indicator indicates AMVR mode is disabled for the video sequence, the apparatus may determine that the affine mode AMVR enablement indicator is not present in the parameter set associated with the video sequence. In examples, the apparatus may set a value of the affine mode AMVR enablement indicator to a value indicative of disabling AMVR for the video sequence with the affine mode enabled in response to a determination that the affine mode AMVR enablement indicator is not present in the parameter set associated with the video sequence.

The apparatus may set the value of the AMVR enablement indicator to a value indicative of disabling AMVR for the video sequence based on general control information (GCI). The apparatus may determine that the affine mode AMVR enablement indicator is not present in the parameter set associated with the video sequence based on the value of the AMVR enablement indicator indicative of disabling AMVR for the video sequence. The apparatus may set a value of the affine mode AMVR enablement indicator to a value indicative of disabling AMVR for the video sequence with the affine mode enabled in response.

The affine mode AMVR enablement indicator may be in the parameter set associated with the video sequence. The parameter set associated with the video sequence may include a sequence parameter set (SPS) associated with the video sequence.

The apparatus may determine that affine mode is enabled for the video sequence based on a value of an affine mode enablement indicator, and the determination of whether the affine mode AMVR enablement indicator is present in the parameter set may be in response to the determination that affine mode is enabled for the video sequence. The affine mode AMVR enablement indicator may indicate whether a combination of the affine mode and AMVR is enabled for the video sequence.

In response to the affine mode AMVR enablement indicator indicating enabling AMVR for the video sequence with the affine mode enabled, the apparatus may adaptively determine a precision of a motion vector difference associated with a coding block of the video sequence based on a coding mode associated with the coding block.

The apparatus may determine that intra block copy (IBC) is enabled for the video sequence, obtain an IBC AMVR enablement indicator in response to the determination that IBC is enabled for the video sequence, and decode the video sequence based on the IBC AMVR enablement indicator.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates a block diagram of an example of a system in which various aspects and examples are implemented.

FIG. 5 illustrates an example of determining whether an affine mode AMVR enablement indicator is present in a parameter set.

FIG. 6 illustrates an example four parameter affine mode model and sub-block level motion derivation for affine blocks.

FIG. 7 illustrates an example six parameter affine mode where V₀, V₁, and V₂ are control points and (MVₓ, MV_{y}) is a motion vector of a sub-block centered at position (x, y).

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

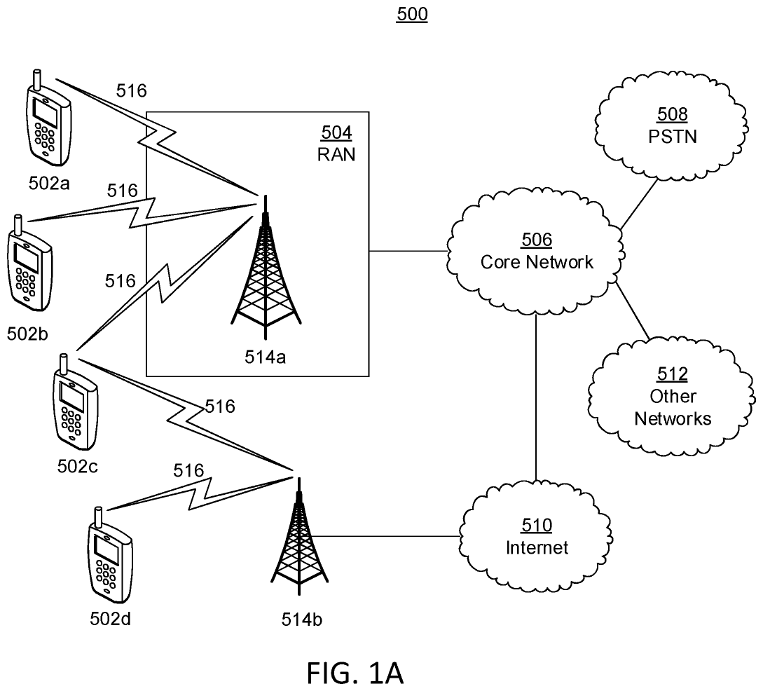

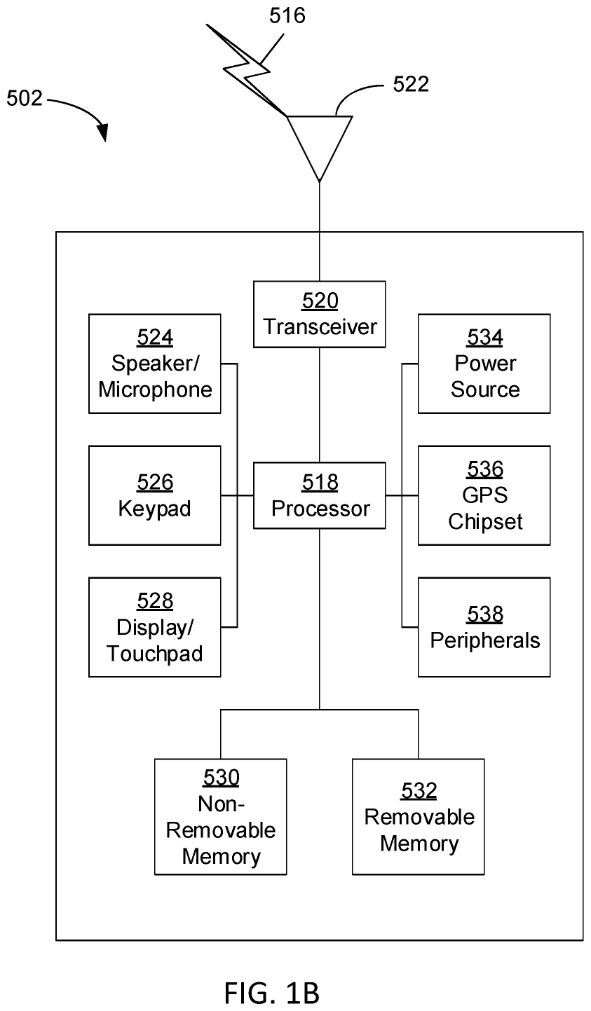

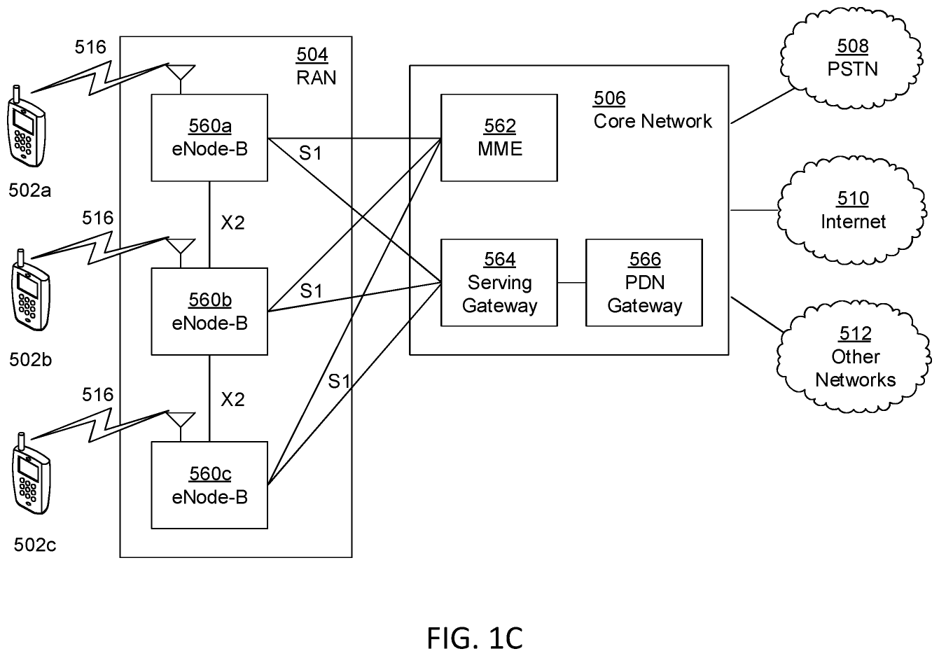

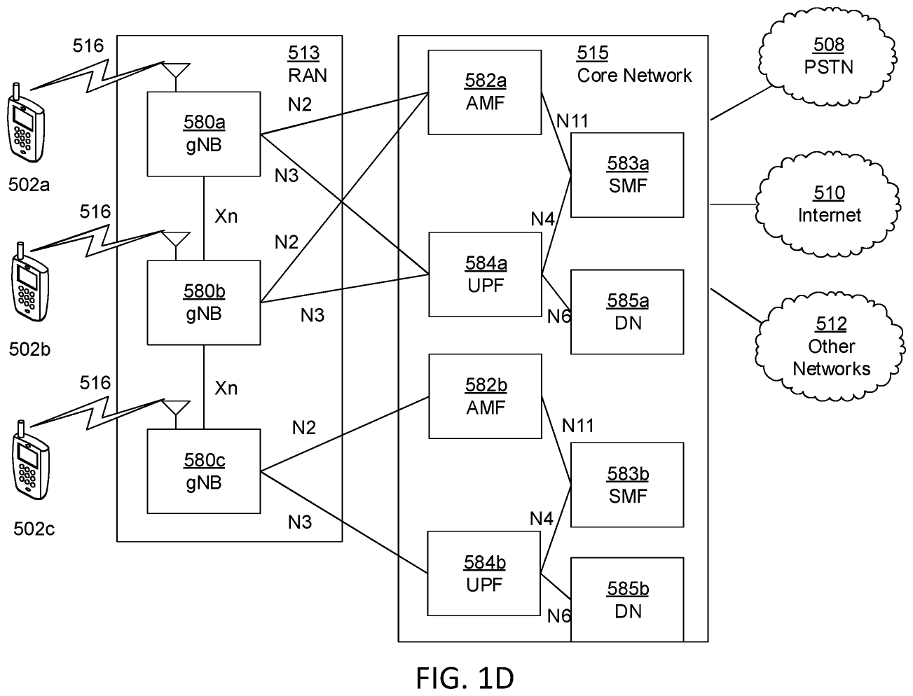

FIG. 1A is a diagram illustrating an example communications system 500 in which one or more disclosed embodiments may be implemented. The communications system 500 may be a multiple access system that provides content, such as voice, data, video, messaging, broadcast, etc., to multiple wireless users. The communications system 500 may enable multiple wireless users to access such content through the sharing of system resources, including wireless bandwidth. For example, the communications systems 500 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 500 may include wireless transmit/receive units (WTRUs) 502a, 502b, 502c, 502d, a RAN 504/513, a CN 506/515, a public switched telephone network (PSTN) 508, the Internet 510, and other networks 512, though it will be appreciated that the disclosed embodiments contemplate any number of WTRUs, base stations, networks, and/or network elements. Each of the WTRUs 502a, 502b, 502c, 502d may be any type of device configured to operate and/or communicate in a wireless environment. By way of example, the WTRUs 502a, 502b, 502c, 502d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 502a, 502b, 502c and 502d may be interchangeably referred to as a UE.

The communications systems 500 may also include a base station 514a and/or a base station 514b. Each of the base stations 514a, 514b may be any type of device configured to wirelessly interface with at least one of the WTRUs 502a, 502b, 502c, 502d to facilitate access to one or more communication networks, such as the CN 506/515, the Internet 510, and/or the other networks 512. By way of example, the base stations 514a, 514b may be a base transceiver station (BTS), a Node-B, an eNode B, a Home Node B, a Home eNode B, a gNB, a NR NodeB, a site controller, an access point (AP), a wireless router, and the like. While the base stations 514a, 514b are each depicted as a single element, it will be appreciated that the base stations 514a, 514b may include any number of interconnected base stations and/or network elements.

The base station 514a may be part of the RAN 504/513, which may also include other base stations and/or network elements (not shown), such as a base station controller (BSC), a radio network controller (RNC), relay nodes, etc. The base station 514a and/or the base station 514b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 514a may be divided into three sectors. Thus, in one embodiment, the base station 514a may include three transceivers, i.e., one for each sector of the cell. In an embodiment, the base station 514a may employ multiple-input multiple output (MIMO) technology and may utilize multiple transceivers for each sector of the cell. For example, beamforming may be used to transmit and/or receive signals in desired spatial directions.

The base stations 514a, 514b may communicate with one or more of the WTRUs 502a, 502b, 502c, 502d over an air interface 516, which may be any suitable wireless communication link (e.g., radio frequency (RF), microwave, centimeter wave, micrometer wave, infrared (IR), ultraviolet (UV), visible light, etc.). The air interface 516 may be established using any suitable radio access technology (RAT).

More specifically, as noted above, the communications system 500 may be a multiple access system and may employ one or more channel access schemes, such as CDMA, TDMA, FDMA, OFDMA, SC-FDMA, and the like. For example, the base station 514a in the RAN 504/513 and the WTRUs 502a, 502b, 502c may implement a radio technology such as Universal Mobile Telecommunications System (UMTS) Terrestrial Radio Access (UTRA), which may establish the air interface 515/516/517 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 514a and the WTRUs 502a, 502b, 502c may implement a radio technology such as Evolved UMTS Terrestrial Radio Access (E-UTRA), which may establish the air interface 516 using Long Term Evolution (LTE) and/or LTE-Advanced (LTE-A) and/or LTE-Advanced Pro (LTE-A Pro).

In an embodiment, the base station 514a and the WTRUs 502a, 502b, 502c may implement a radio technology such as NR Radio Access, which may establish the air interface 516 using New Radio (NR).

In an embodiment, the base station 514a and the WTRUs 502a, 502b, 502c may implement multiple radio access technologies. For example, the base station 514a and the WTRUs 502a, 502b, 502c may implement LTE radio access and NR radio access together, for instance using dual connectivity (DC) principles. Thus, the air interface utilized by WTRUs 502a, 502b, 502c may be characterized by multiple types of radio access technologies and/or transmissions sent to/from multiple types of base stations (e.g., an eNB and a gNB).

In other embodiments, the base station 514a and the WTRUs 502a, 502b, 502c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 514b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 514b and the WTRUs 502c, 502d may implement a radio technology such as IEEE 802.11 to establish a wireless local area network (WLAN). In an embodiment, the base station 514b and the WTRUs 502c, 502d may implement a radio technology such as IEEE 802.15 to establish a wireless personal area network (WPAN). In yet another embodiment, the base station 514b and the WTRUs 502c, 502d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 514b may have a direct connection to the Internet 510. Thus, the base station 514b may not be required to access the Internet 510 via the CN 506/515.

The RAN 504/513 may be in communication with the CN 506/515, which may be any type of network configured to provide voice, data, applications, and/or voice over internet protocol (VoIP) services to one or more of the WTRUs 502a, 502b, 502c, 502d. The data may have varying quality of service (QoS) requirements, such as differing throughput requirements, latency requirements, error tolerance requirements, reliability requirements, data throughput requirements, mobility requirements, and the like. The CN 506/515 may provide call control, billing services, mobile location-based services, pre-paid calling, Internet connectivity, video distribution, etc., and/or perform high-level security functions, such as user authentication. Although not shown in FIG. 1A, it will be appreciated that the RAN 504/513 and/or the CN 506/515 may be in direct or indirect communication with other RANs that employ the same RAT as the RAN 504/513 or a different RAT. For example, in addition to being connected to the RAN 504/513, which may be utilizing a NR radio technology, the CN 506/515 may also be in communication with another RAN (not shown) employing a GSM, UMTS, CDMA 2000, WiMAX, E-UTRA, or WiFi radio technology.

The CN 506/515 may also serve as a gateway for the WTRUs 502a, 502b, 502c, 502d to access the PSTN 508, the Internet 510, and/or the other networks 512. The PSTN 508 may include circuit-switched telephone networks that provide plain old telephone service (POTS). The Internet 510 may include a global system of interconnected computer networks and devices that use common communication protocols, such as the transmission control protocol (TCP), user datagram protocol (UDP) and/or the internet protocol (IP) in the TCP/IP internet protocol suite. The networks 512 may include wired and/or wireless communications networks owned and/or operated by other service providers. For example, the networks 512 may include another CN connected to one or more RANs, which may employ the same RAT as the RAN 504/513 or a different RAT.

Some or all of the WTRUs 502a, 502b, 502c, 502d in the communications system 500 may include multi-mode capabilities (e.g., the WTRUs 502a, 502b, 502c, 502d may include multiple transceivers for communicating with different wireless networks over different wireless links). For example, the WTRU 502c shown in FIG. 1A may be configured to communicate with the base station 514a, which may employ a cellular-based radio technology, and with the base station 514b, which may employ an IEEE 802 radio technology.

FIG. 1B is a system diagram illustrating an example WTRU 502. As shown in FIG. 1B, the WTRU 502 may include a processor 518, a transceiver 520, a transmit/receive element 522, a speaker/microphone 524, a keypad 526, a display/touchpad 528, non-removable memory 530, removable memory 532, a power source 534, a global positioning system (GPS) chipset 536, and/or other peripherals 538, among others. It will be appreciated that the WTRU 502 may include any sub-combination of the foregoing elements while remaining consistent with an embodiment.

The processor 518 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 518 may perform signal coding, data processing, power control, input/output processing, and/or any other functionality that enables the WTRU 502 to operate in a wireless environment. The processor 518 may be coupled to the transceiver 520, which may be coupled to the transmit/receive element 522. While FIG. 1B depicts the processor 518 and the transceiver 520 as separate components, it will be appreciated that the processor 518 and the transceiver 520 may be integrated together in an electronic package or chip.

The transmit/receive element 522 may be configured to transmit signals to, or receive signals from, a base station (e.g., the base station 514a) over the air interface 516. For example, in one embodiment, the transmit/receive element 522 may be an antenna configured to transmit and/or receive RF signals. In an embodiment, the transmit/receive element 522 may be an emitter/detector configured to transmit and/or receive IR, UV, or visible light signals, for example. In yet another embodiment, the transmit/receive element 522 may be configured to transmit and/or receive both RF and light signals. It will be appreciated that the transmit/receive element 522 may be configured to transmit and/or receive any combination of wireless signals.

Although the transmit/receive element 522 is depicted in FIG. 1B as a single element, the WTRU 502 may include any number of transmit/receive elements 522. More specifically, the WTRU 502 may employ MIMO technology. Thus, in one embodiment, the WTRU 502 may include two or more transmit/receive elements 522 (e.g., multiple antennas) for transmitting and receiving wireless signals over the air interface 516.

The transceiver 520 may be configured to modulate the signals that are to be transmitted by the transmit/receive element 522 and to demodulate the signals that are received by the transmit/receive element 522. As noted above, the WTRU 502 may have multi-mode capabilities. Thus, the transceiver 520 may include multiple transceivers for enabling the WTRU 502 to communicate via multiple RATs, such as NR and IEEE 802.11, for example.

The processor 518 of the WTRU 502 may be coupled to, and may receive user input data from, the speaker/microphone 524, the keypad 526, and/or the display/touchpad 528 (e.g., a liquid crystal display (LCD) display unit or organic light-emitting diode (OLED) display unit). The processor 518 may also output user data to the speaker/microphone 524, the keypad 526, and/or the display/touchpad 528. In addition, the processor 518 may access information from, and store data in, any type of suitable memory, such as the non-removable memory 530 and/or the removable memory 532. The non-removable memory 530 may include random-access memory (RAM), read-only memory (ROM), a hard disk, or any other type of memory storage device. The removable memory 532 may include a subscriber identity module (SIM) card, a memory stick, a secure digital (SD) memory card, and the like. In other embodiments, the processor 518 may access information from, and store data in, memory that is not physically located on the WTRU 502, such as on a server or a home computer (not shown).

The processor 518 may receive power from the power source 534, and may be configured to distribute and/or control the power to the other components in the WTRU 502. The power source 534 may be any suitable device for powering the WTRU 502. For example, the power source 534 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 518 may also be coupled to the GPS chipset 536, which may be configured to provide location information (e.g., longitude and latitude) regarding the current location of the WTRU 502. In addition to, or in lieu of, the information from the GPS chipset 536, the WTRU 502 may receive location information over the air interface 516 from a base station (e.g., base stations 514a, 514b) and/or determine its location based on the timing of the signals being received from two or more nearby base stations. It will be appreciated that the WTRU 502 may acquire location information by way of any suitable location-determination method while remaining consistent with an embodiment.

The processor 518 may further be coupled to other peripherals 538, which may include one or more software and/or hardware modules that provide additional features, functionality and/or wired or wireless connectivity. For example, the peripherals 538 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 538 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 502 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 518). In an embodiment, the WRTU 502 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 504 and the CN 506 according to an embodiment. As noted above, the RAN 504 may employ an E-UTRA radio technology to communicate with the WTRUs 502a, 502b, 502c over the air interface 516. The RAN 504 may also be in communication with the CN 506.

The RAN 504 may include eNode-Bs 560a, 560b, 560c, though it will be appreciated that the RAN 504 may include any number of eNode-Bs while remaining consistent with an embodiment. The eNode-Bs 560a, 560b, 560c may each include one or more transceivers for communicating with the WTRUs 502a, 502b, 502c over the air interface 516. In one embodiment, the eNode-Bs 560a, 560b, 560c may implement MIMO technology. Thus, the eNode-B 560a, for example, may use multiple antennas to transmit wireless signals to, and/or receive wireless signals from, the WTRU 502a.

Each of the eNode-Bs 560a, 560b, 560c may be associated with a particular cell (not shown) and may be configured to handle radio resource management decisions, handover decisions, scheduling of users in the UL and/or DL, and the like. As shown in FIG. 1C, the eNode-Bs 560a, 560b, 560c may communicate with one another over an X2 interface.

The CN 506 shown in FIG. 1C may include a mobility management entity (MME) 562, a serving gateway (SGW) 564, and a packet data network (PDN) gateway (or PGW) 566. While each of the foregoing elements are depicted as part of the CN 506, it will be appreciated that any of these elements may be owned and/or operated by an entity other than the CN operator.

The MME 562 may be connected to each of the eNode-Bs 562a, 562b, 562c in the RAN 504 via an S1 interface and may serve as a control node. For example, the MME 562 may be responsible for authenticating users of the WTRUs 502a, 502b, 502c, bearer activation/deactivation, selecting a particular serving gateway during an initial attach of the WTRUs 502a, 502b, 502c, and the like. The MME 562 may provide a control plane function for switching between the RAN 504 and other RANs (not shown) that employ other radio technologies, such as GSM and/or WCDMA.

The SGW 564 may be connected to each of the eNode Bs 560a, 560b, 560c in the RAN 504 via the S1 interface. The SGW 564 may generally route and forward user data packets to/from the WTRUs 502a, 502b, 502c. The SGW 564 may perform other functions, such as anchoring user planes during inter-eNode B handovers, triggering paging when DL data is available for the WTRUs 502a, 502b, 502c, managing and storing contexts of the WTRUs 502a, 502b, 502c, and the like.

The SGW 564 may be connected to the PGW 566, which may provide the WTRUs 502a, 502b, 502c with access to packet-switched networks, such as the Internet 510, to facilitate communications between the WTRUs 502a, 502b, 502c and IP-enabled devices.

The CN 506 may facilitate communications with other networks. For example, the CN 506 may provide the WTRUs 502a, 502b, 502c with access to circuit-switched networks, such as the PSTN 508, to facilitate communications between the WTRUs 502a, 502b, 502c and traditional land-line communications devices. For example, the CN 506 may include, or may communicate with, an IP gateway (e.g., an IP multimedia subsystem (IMS) server) that serves as an interface between the CN 506 and the PSTN 508. In addition, the CN 506 may provide the WTRUs 502a, 502b, 502c with access to the other networks 512, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 512 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 513 and the CN 515 according to an embodiment. As noted above, the RAN 513 may employ an NR radio technology to communicate with the WTRUs 502a, 502b, 502c over the air interface 516. The RAN 513 may also be in communication with the CN 515.

The RAN 513 may include gNBs 580a, 580b, 580c, though it will be appreciated that the RAN 513 may include any number of gNBs while remaining consistent with an embodiment. The gNBs 580a, 580b, 580c may each include one or more transceivers for communicating with the WTRUs 502a, 502b, 502c over the air interface 516. In one embodiment, the gNBs 580a, 580b, 580c may implement MIMO technology. For example, gNBs 580a, 508b may utilize beamforming to transmit signals to and/or receive signals from the gNBs 580a, 580b, 580c. Thus, the gNB 580a, for example, may use multiple antennas to transmit wireless signals to, and/or receive wireless signals from, the WTRU 502a. In an embodiment, the gNBs 580a, 580b, 580c may implement carrier aggregation technology. For example, the gNB 580a may transmit multiple component carriers to the WTRU 502a (not shown). A subset of these component carriers may be on unlicensed spectrum while the remaining component carriers may be on licensed spectrum. In an embodiment, the gNBs 580a, 580b, 580c may implement Coordinated Multi-Point (CoMP) technology. For example, WTRU 502a may receive coordinated transmissions from gNB 580a and gNB 580b (and/or gNB 580c).

The WTRUs 502a, 502b, 502c may communicate with gNBs 580a, 580b, 580c using transmissions associated with a scalable numerology. For example, the OFDM symbol spacing and/or OFDM subcarrier spacing may vary for different transmissions, different cells, and/or different portions of the wireless transmission spectrum. The WTRUs 502a, 502b, 502c may communicate with gNBs 580a, 580b, 580c using subframe or transmission time intervals (TTIs) of various or scalable lengths (e.g., containing varying number of OFDM symbols and/or lasting varying lengths of absolute time).

The gNBs 580a, 580b, 580c may be configured to communicate with the WTRUs 502a, 502b, 502c in a standalone configuration and/or a non-standalone configuration. In the standalone configuration, WTRUs 502a, 502b, 502c may communicate with gNBs 580a, 580b, 580c without also accessing other RANs (e.g., such as eNode-Bs 560a, 560b, 560c). In the standalone configuration, WTRUs 502a, 502b, 502c may utilize one or more of gNBs 580a, 580b, 580c as a mobility anchor point. In the standalone configuration, WTRUs 502a, 502b, 502c may communicate with gNBs 580a, 580b, 580c using signals in an unlicensed band. In a non-standalone configuration WTRUs 502a, 502b, 502c may communicate with/connect to gNBs 580a, 580b, 580c while also communicating with/connecting to another RAN such as eNode-Bs 560a, 560b, 560c. For example, WTRUs 502a, 502b, 502c may implement DC principles to communicate with one or more gNBs 580a, 580b, 580c and one or more eNode-Bs 560a, 560b, 560c substantially simultaneously. In the non-standalone configuration, eNode-Bs 560a, 560b, 560c may serve as a mobility anchor for WTRUs 502a, 502b, 502c and gNBs 580a, 580b, 580c may provide additional coverage and/or throughput for servicing WTRUs 502a, 502b, 502c.

Each of the gNBs 580a, 580b, 580c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 584a, 584b, routing of control plane information towards Access and Mobility Management Function (AMF) 582a, 582b and the like. As shown in FIG. 1D, the gNBs 580a, 580b, 580c may communicate with one another over an Xn interface.

The CN 515 shown in FIG. 1D may include at least one AMF 582a, 582b, at least one UPF 584a,584b, at least one Session Management Function (SMF) 583a, 583b, and possibly a Data Network (DN) 585a, 585b. While each of the foregoing elements are depicted as part of the CN 515, it will be appreciated that any of these elements may be owned and/or operated by an entity other than the CN operator.

The AMF 582a, 582b may be connected to one or more of the gNBs 580a, 580b, 580c in the RAN 513 via an N2 interface and may serve as a control node. For example, the AMF 582a, 582b may be responsible for authenticating users of the WTRUs 502a, 502b, 502c, support for network slicing (e.g., handling of different PDU sessions with different requirements), selecting a particular SMF 583a, 583b, management of the registration area, termination of NAS signaling, mobility management, and the like. Network slicing may be used by the AMF 582a, 582b in order to customize CN support for WTRUs 502a, 502b, 502c based on the types of services being utilized WTRUs 502a, 502b, 502c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 562 may provide a control plane function for switching between the RAN 513 and other RANs (not shown) that employ other radio technologies, such as LTE, LTE-A, LTE-A Pro, and/or non-3GPP access technologies such as WiFi.

The SMF 583a, 583b may be connected to an AMF 582a, 582b in the CN 515 via an N11 interface. The SMF 583a, 583b may also be connected to a UPF 584a, 584b in the CN 515 via an N4 interface. The SMF 583a, 583b may select and control the UPF 584a, 584b and configure the routing of traffic through the UPF 584a, 584b. The SMF 583a, 583b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 584a, 584b may be connected to one or more of the gNBs 580a, 580b, 580c in the RAN 513 via an N3 interface, which may provide the WTRUs 502a, 502b, 502c with access to packet-switched networks, such as the Internet 510, to facilitate communications between the WTRUs 502a, 502b, 502c and IP-enabled devices. The UPF 584, 584b may perform other functions, such as routing and forwarding packets, enforcing user plane policies, supporting multi-homed PDU sessions, handling user plane QoS, buffering downlink packets, providing mobility anchoring, and the like.

The CN 515 may facilitate communications with other networks. For example, the CN 515 may include, or may communicate with, an IP gateway (e.g., an IP multimedia subsystem (IMS) server) that serves as an interface between the CN 515 and the PSTN 508. In addition, the CN 515 may provide the WTRUs 502a, 502b, 502c with access to the other networks 512, which may include other wired and/or wireless networks that are owned and/or operated by other service providers. In one embodiment, the WTRUs 502a, 502b, 502c may be connected to a local Data Network (DN) 585a, 585b through the UPF 584a, 584b via the N3 interface to the UPF 584a, 584b and an N6 interface between the UPF 584a, 584b and the DN 585a, 585b.

In view of FIGS. 1A-1D, and the corresponding description of FIGS. 1A-1D, one or more, or all, of the functions described herein with regard to one or more of: WTRU 502a-d, Base Station 514a-b, eNode-B 560a-c, MME 562, SGW 564, PGW 566, gNB 580a-c, AMF 582a-b, UPF 584a-b, SMF 583a-b, DN 585a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

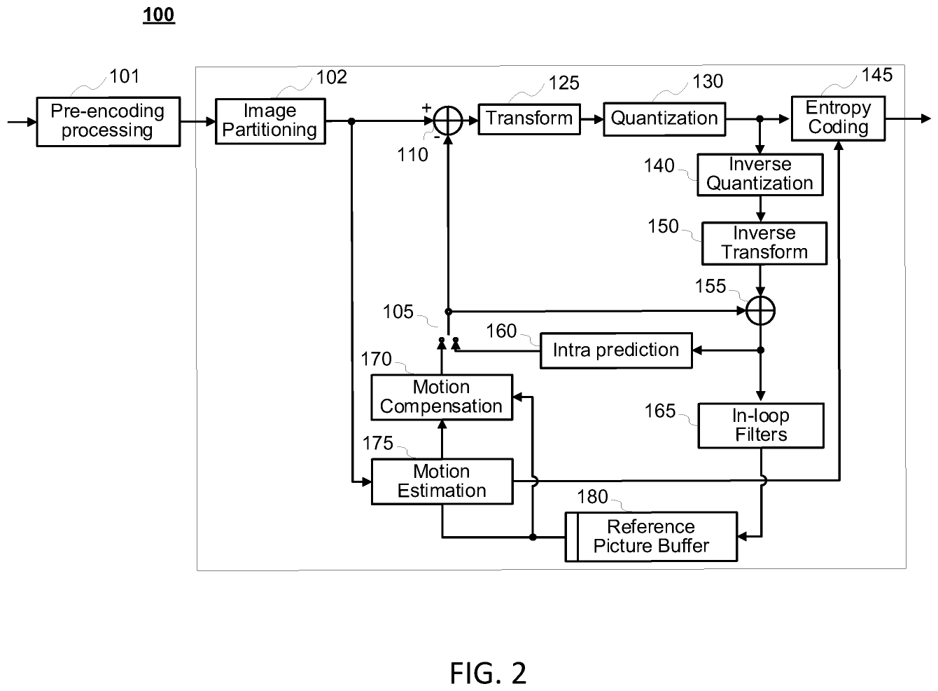

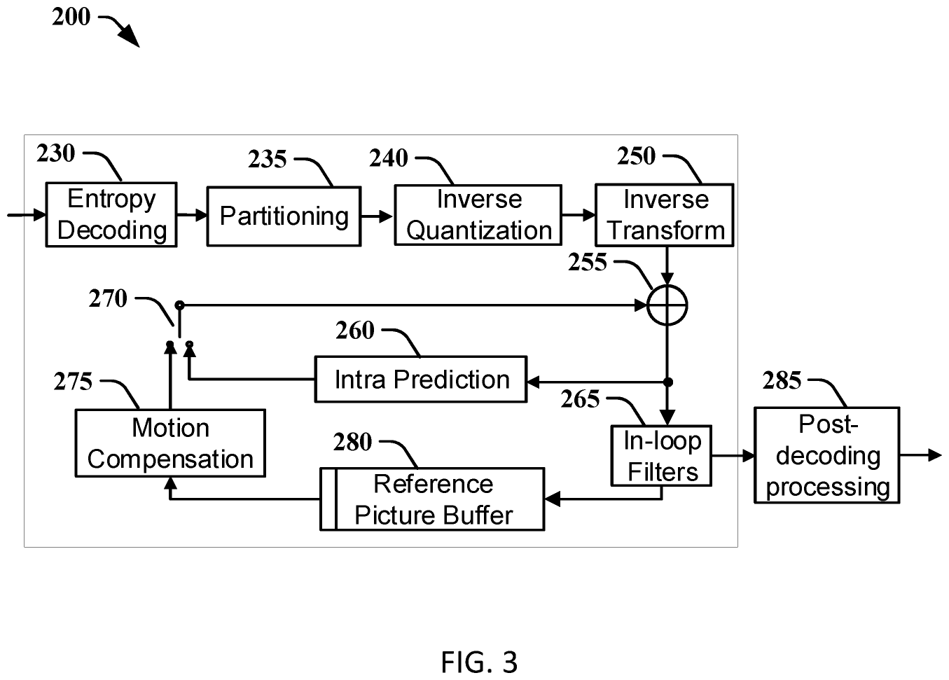

The aspects described and contemplated in this application can be implemented in many different forms. FIGS. 2 and 3 described herein may provide some embodiments, but other embodiments are contemplated and the discussion of FIGS. 2, 3, and 4 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra prediction, entropy coding, and/or decoding modules (160, 260, 145, 230), of a video encoder 100 and decoder 200 as shown in FIG. 2 and FIG. 3. Moreover, the present aspects are not limited to WC or HEVC, and can be applied, for example, to other standards and recommendations, whether pre-existing or future-developed, and extensions of any such standards and recommendations (including WC and HEVC). Unless indicated otherwise, or technically precluded, the aspects described in this application can be used individually or in combination.

Various numeric values are used in the present application, for example, MaxNumMergeCand less than two, pic_six_minus_max_num_merge_cand greater than 4 or 5, if MaxNumMergeCand is 1 then MaxNumTriangleMergeCand may be set to 2, the maximum number of merge candidates for triangle may range from 2 to 5, AMVR precision index (for example, amvr_precision_idx) may be either 0 or 1 for affine and IBC, AMVR precision index may be 0, 1, or 2 for regular mode, the array index cldx equal to 0 for Y, 1 for Cb, and 2 for Cr, no_amvr_constraint_flag equal to 0 or 1, sps_amvr_enabled_flag equal to 0, sps_affine_amvr_enabled_flag equal to 0. etc. The specific values are for example purposes and the aspects described are not limited to these specific values.

FIG. 2 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (for example, conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 3 illustrates a block diagram of a video decoder 200. In the decoder 200, a bitstream is decoded by the decoder elements as described below. Video decoder 200 generally performs a decoding pass reciprocal to the encoding pass as described in FIG. 2. The encoder 100 also generally performs video decoding as part of encoding video data. For example, the encoder 100 may perform one or more of the video decoding steps presented herein. The encoder reconstructs the decoded images, for example, to maintain synchronization with the decoder with respect to one or more of the following: reference pictures, entropy coding contexts, and other decoder-relevant state variables.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (for example conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

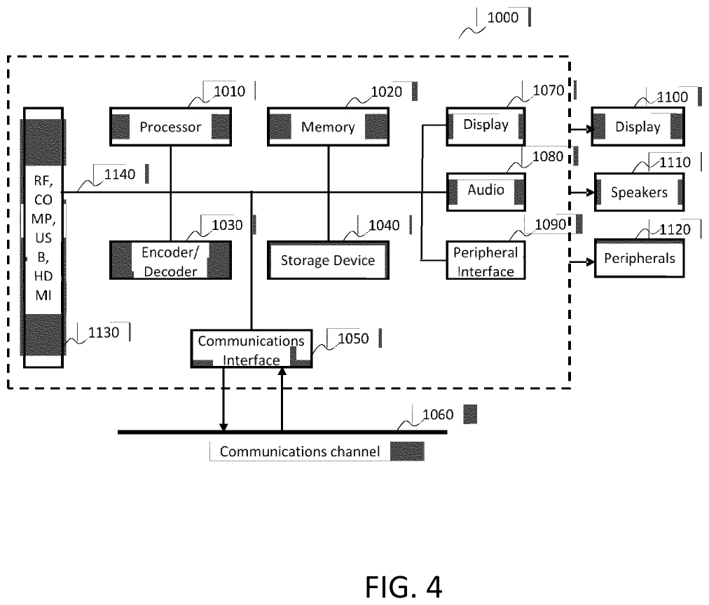

FIG. 4 illustrates a block diagram of an example of a system in which various aspects and embodiments are implemented. System 1000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (for example, a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples. When the processor 1010 encompasses multiple processors, the multiple processors can share the operations related to the embodiments.

Video compression may be performed. Various indications related to merge mode, adaptive motion vector resolution (AMVR), transform unit (TU) level indicator of Transform Skip (TrSkip), and/or constraint indicators may be included in the bitstream (for example, by a video coding device such as an encoder). These indications may be received by a video coding device such as a decoder for reconstructing a video. Merge mode related indications in syntax (for example, high level syntax (HLS)) may be signaled. AMVR related indications may be signaled as described herein. The TU level flag of TrSkip may be signaled as described herein. One or more constraint flags may be signaled as described herein.

A video coding device (for example, an encoder) may signal a check condition in a picture header (PH) raw byte sequence payload (RBSP) semantics that sets a maximum number of triangular partition mode (TPM) candidates to two. A video coding device (for example, a decoder) may perform prediction using TPM based on the check condition. The video coding device may decouple a number of merge candidates in TPM/Geo from regular merge mode. A video coding device (for example, a decoder) may perform prediction with merge using the number of merge candidates in TPM/Geo and/or regular merge mode. The video coding device may signal a sequence parameter set (SPS) flag for intra block copy (IBC) adaptive motion vector resolution (AMVR), allowing IBC-AMVR combination if AMVR is activated. The video coding device may exclude an affine AMVR SPS flag from the bitstream (for example, not signal an affine AMVR SPS flag in the bitstream). The video coding device may signal TrSkip at a coding unit (CU) level. A video coding device (for example, a decoder) may determine whether a transform block is coded using TrSkip, for example, based on a TrSkip indication received at the CU level.

The video coding device (for example, a decoder) may determine whether affine mode AMVR is disabled based on constraint flag no_amvr_constraint_flag, and set the SPS affine AMVR enabled flag accordingly. The video coding device may set the sps_explicit_mts_intra_enabled_flag and sps_explicit_mts_inter_enabled_flag based on constraint flag no_mts_constraint_flag. The video coding device may set the sps_bdpcm_enabled_flag and sps_bdpcm_chroma_enabled_flag based on constraint flag no_transform_skip_constraint_flag. The video coding device may set the sps_bdcpm_chroma_enabled_flag based on constraint flag no_bdpcm_constraint_flag.

A number of merge candidates of a triangular partitioning mode (TPM) may be determined based on (for example, controlled by) a high-level syntax flag. The number of merge candidates may be set to zero and TPM may be disabled, for example, if the number of regular merge candidates is less than 2. In some examples, TPM may be disabled in some condition(s) even if it is activated by a flag (for example, an SPS flag).

AMVR may have (for example, include) different resolutions for regular inter predicted coding units (CU's), affine motion predicted CU's, and CU's coded with intra block copy (IBC). HLS flags may be signaled to control AMVR for regular inter predicted CU's and affine motion predicted CU's, respectively.

Although certain examples may be described in terms of coding units, the examples may be equally applicable to coding blocks. Thus, in a sense these terms may be interchangeably used, and examples described in terms of coding units may be equally applicable to coding blocks.

Multiple transform selection (MTS) and/or low frequency non-separable transform (LFNST) indexes may be performed at a CU level. In some examples, a TrSkip flag may be received at the TU level, and TrSkip may be checked to determine if CU level MTS and LFNST indexes are coded.

A set of one or more constraint flags may be signaled to perform specified functionality and/or avoid undefined behavior. The number of merge candidates of regular inter predicted CU's may be decoupled from CU's with TPM. TPM may be activated, for example, by decoupling the merge candidates. Decoupling the merge candidates may ensure the activation of TPM. For example, TPM may be activated according to the number of merge candidates. An indication (for example, a SPS flag) may control a combination of IBC and AMVR, for example, to have the same degree of freedom as affine mode or inter prediction. A TrSkip flag may be signaled/received at a CU level.

A maximum number of merge candidates may be coded at a picture parameter set (PPS) level and/or a picture header (PH) level. Regular merge, affine, triangle, and IBC may each include a specific maximum number of merge candidates. At a PPS level, the maximum number of regular merge and TPM may be coded. An example PPS syntax is shown in Table 1.

TABLE 1
Example PPS Syntax

| | Descriptor |
|---|---|
| pic_parameter_set_rbsp( ) { | |
| ... | |
| constant_slice_header_params_enabled_flag | u(1) |
| if( constant_slice_header_params_enabled_flag ) { | |
| ... | |
| pps_six_minus_max_num_merge_cand_plus1 | ue(v) |
| pps_max_num_merge_cand_minus_max_num_triangle_cand_plus1 | ue(v) |
| } | |
| ... | |
| } | |

At the PH level, the number of candidates for coding tools may be indicated. An example PH syntax is shown in Table 2.

TABLE 2
Example PH Syntax

| | Descriptor |
|---|---|
| picture_header_rbsp( ) { | |
| ... | u(1) |
| if( !pps_six_minus_max_num_merge_cand_plus1 ) | |
| pic_six_minus_max_num_merge_cand | ue(v) |
| if( sps_affine_enabled_flag ) | |
| pic_five_minus_max_num_subblock_merge_cand | ue(v) |
| ... | |
| if( sps_triangle_enabled_flag && MaxNumMergeCand >= 2 && | |
| !pps_max_num_merge_cand_minus_max_num_triangle_cand_plus1 ) | |
| pic_max_num_merge_cand_minus_max_num_triangle_cand | ue(v) |
| if ( sps_ibc_enabled_flag ) | |
| pic_six_minus_max_num_ibc_merge_cand | ue(v) |
| ... | |
| } | |

In some example, TPM may be disabled if a maximum number of candidates of regular merge mode is 1. For example, a video coding device (for example, such as a decoder) may determine to perform prediction with TPM disabled when the maximum number of candidates of regular merge mode is 1. An example merge data syntax is shown in Table 3.

TABLE 3
Example merge data syntax

| | Descriptor |
|---|---|
| merge_data( x0, y0, cbWidth, cbHeight, chType ) { | |
| if( CuPredMode[ chType ][ x0 ][ y0 ] = = MODE_IBC ) { | |
| ... | |
| } else { | |
| ... | |
| if( merge_subblock_flag[ x0 ][ y0 ] = = 1 ) { | |
| ... | |
| } else { | |
| if( ( cbWidth * cbHeight ) >= 64 && ( ( sps_ciip_enabled_flag && | |
| cu_skip_flag[ x0 ][ y0 ] = = 0 && cbWidth < 128 && cbHeight < 128 ) \| \| | |
| ( sps_triangle_enabled_flag && MaxNumTriangleMergeCand > 1 && | |
| slice_type = = B ) ) ) | |
| regular_merge_flag[ x0 ][ y0 ] | ae(v) |
| if( regular_merge_flag[ x0 ][ y0 ] = = 1 ) { | |
| ... | ... |
| } else { | |
| ... | |
| if( !ciip_flag[ x0 ][ y0 ] && MaxNumTriangleMergeCand > 1 ) { | |
| merge_triangle_split_dir[ x0 ][ y0 ] | ae(v) |
| ... | |
| } | |
| } | |
| } | |
| } | |
| } | |

In some examples, TPM may be deactivated regardless of the value of a SPS triangle partition enabled flag (for example, sps_triangle_enabled_flag), unless the maximum number of triangular merge mode candidates (for example, MaxNumTriangleMergeCand) is greater than 1. At the encoder side, a triangle mode may be enabled at the SPS level, and triangle mode may be deactivated based on the number of merge candidates.

The maximum number of triangular merge mode candidates (for example, MaxNumTriangleMergeCand) may be determined based on a maximum number of merge candidates (for example, MaxNumMergeCand) and/or a maximum number of triangle mode candidates supported subtracted from the maximum number of merge candidates. Example PH RBSP semantics is shown in Table 4.

TABLE 4
Example picture header RBSP semantics

7.4.3.6 Picture header RBSP semantics
...
MaxNumMergeCand = 6 − pic_six_minus_max_num_merge_cand (85)
The value of MaxNumMergeCand shall be in the range of 1 to 6, inclusive. When not present, the
value of pic_six_minus_max_num_merge_cand is inferred to be equal to
pps_six_minus_max_num_merge_cand_plus1 − 1.
...
When pic_max_num_merge_cand_minus_max_num_triangle_cand is not present, and
sps_triangle_enabled_flag is equal to 1 and MaxNumMergeCand greater than or equal to 2,
pic_max_num_merge_cand_minus_max_num_triangle_cand is inferred to be equal to
pps_max_num_merge_cand_minus_max_num_triangle_cand_plus1 − 1.
The maximum number of triangular merge mode candidates, MaxNumTriangleMergeCand is derived
as follows:
MaxNumTriangleMergeCand
=
MaxNumMergeCand − pic_max_num_merge_cand_minus_max_num_triangle_cand (87)
When pic_max_num_merge_cand_minus_max_num_triangle_cand is present, the value of
MaxNumTriangleMergeCand shall be in the range of 2 to MaxNumMergeCand, inclusive.
When pic_max_num_merge_cand_minus_max_num_triangle_cand is not present, and
(sps_triangle_enabled_flag is equal to 0 or MaxNumMergeCand is less than 2),
MaxNumTriangleMergeCand is set equal to 0.
When MaxNumTriangleMergeCand is equal to 0, triangle merge mode is not allowed for the slices
associated with the PH.
...

A value of MaxNumMergeCand may be less than two, for example, when pic_six_minus_max_num_merge_cand is greater than 4 (for example, as shown in eq. 85). In this case MaxNumTriangleMergeCand may be set to zero, merge_triangle_split_dir may not be decoded at a merge_data function, and TPM may be deactivated.

In some examples, a maximum number of TPM candidates may be set to 2. In some examples, a minimum number of TPM candidates may be set to 2. In some examples, a check may be performed before setting the maximum number of triangular merge mode candidates. The check condition may specify that if MaxNumMergeCand is equal to 1, MaxNumTriangleMergeCand may be set to 2. In this case, TPM may be activated if its SPS flag is activated. An example PH RBSP semantics is shown in Table 5.

TABLE 5
Example picture header RBSP semantics

7.4.3.6 Picture header RBSP semantics
...
MaxNumMergeCand = 6 − pic_six_minus_max_num_merge_cand (85)
The value of MaxNumMergeCand shall be in the range of 1 to 6, inclusive. When not present, the
value of pic_six_minus_max_num_merge_cand is inferred to be equal to
pps_six_minus_max_num_merge_cand_plus1 − 1.
...
When pic_max_num_merge_cand_minus_max_num_triangle_cand is not present, and
sps_triangle_enabled_flag is equal to 1 and MaxNumMergeCand greater than or equal to 2,
pic_max_num_merge_cand_minus_max_num_triangle_cand is inferred to be equal to
pps_max_num_merge_cand_minus_max_num_triangle_cand_plus1 − 1.
The maximum number of triangular merge mode candidates, MaxNumTriangleMergeCand is derived
as follows:
MaxNumTriangleMergeCand =
MaxNumMergeCand − pic_max_num_merge_cand_minus_max_num_triangle_cand (87)
When pic_max_num_merge_cand_minus_max_num_triangle_cand is present, the value of
MaxNumTriangleMergeCand shall be in the range of 2 to MaxNumMergeCand, inclusive.
When pic_max_num_merge_cand_minus_max_num_triangle_cand is not present, and
(sps_triangle_enabled_flag is equal to 0), MaxNumTriangleMergeCand is set equal to 0.
When pic_max_num_merge_cand_minus_max_num_triangle_cand is not present, and
(sps_triangle_enabled_flag is equal to 1 and MaxNumMergeCand is less than 2),
MaxNumTriangleMergeCand is set equal to 2.
When MaxNumTriangleMergeCand is equal to 0, triangle merge mode is not allowed for the slices
associated with the PH.
...

A maximum number of merge candidates of a regular merge mode may be decoupled from a maximum number of merge candidates of TPM. The maximum number of merge candidates of TPM may be determined independently from the maximum number of merge candidates of the regular merge mode. For example, the maximum number of merge candidates of TPM may be determined based on an indication in the PPS, the PH, and/or in the SPS, or the like. The indication that indicates the maximum number of merge candidates of TPM may be or may include pic_five_minus_max_num_triangle_cand, for example, as shown in Tables 6, 7 and 9.

For example, when separate merge and TPM indications are signaled (for example, in PPS, PH, and/or merge data syntax, or the like), the maximum number of merge candidates of the regular merge mode may be decoupled from the maximum number of merge candidates of TPM. For example, a video coding device (for example, a decoder) may determine that the maximum number of merge candidates of the regular merge mode is decoupled from the maximum number of merge candidates of TPM when separate regular merge and TPM indications are included in the PPS, PH, and/or merge data syntax. Example PPS syntax is shown in Table 6, example PH syntax is shown in Table 7, example merge data syntax is shown in Table 8, and example PH RBSP semantics is shown in Table 9.

TABLE 6
Example PPS syntax

| | De- |
|---|---|
| | scrip- |
| | tor |
| pic_parameter_set_rbsp( ) { | |
| ... | |
| constant_slice_header_params_enabled_flag | u(1) |
| if( constant_slice_header_params_enabled_flag ) { | |
| ... | |
| pps_six_minus_max_num_merge_cand_plus1 | ue(v) |
| pps_five_cand_minus_max_num_triangle_cand_plus1 | ue(v) |
| } | |
| ... | |
| } | |

TABLE 7
Example PH syntax

| | Descriptor |
|---|---|
| picture_header_rbsp( ) { | |
| ... | u(1) |
| if( !pps_six_minus_max_num_merge_cand_plus1 ) | |
| pic_six_minus_max_num_merge_cand | ue(v) |
| if( sps_affine_enabled_flag ) | |
| pic_five_minus_max_num_subblock_merge_cand | ue(v) |
| ... | |
| if( sps_triangle_enabled_flag && | |
| !pps_five_minus_max_num_triangle_cand_plus1 ) | |
| pic_five_minus_max_num_triangle_cand | ue(v) |
| if ( sps_ibc_enabled_flag ) | |
| pic_six_minus_max_num_ibc_merge_cand | ue(v) |
| ... | |
| } | |

TABLE 8
Example merge data syntax

| | Descriptor |
|---|---|
| merge_data( x0, y0, cbWidth, cbHeight, chType ) { | |
| if( CuPredMode[ chType ][ x0 ][ y0 ] = = MODE_IBC ) { | |
| ... | |
| } else { | |
| ... | |
| if( merge_subblock_flag[ x0 ][ y0 ] = = 1 ) { | |
| ... | |
| } else { | |
| if( ( cbWidth * cbHeight ) >= 64 && ( (sps_ciip_enabled_flag && | |
| cu_skip_flag[ x0 ][y0 ] = = 0 && cbWidth < 128 && cbHeight < 128 ) \| \| | |
| ( sps_triangle_enabled_flag && | |
| slice_type = = B ) ) ) | |
| regular_merge_flag[ x0 ][ y0 ] | ae(v) |
| if( regular_merge_flag[ x0 ][ y0 ] = = 1 ) { | |
| ... | ... |
| } else { | |
| ... | |
| if( !ciip_flag[ x0 ][ y0 ] && ) { | |
| merge_triangle_split_dir[ x0 ][ y0 ] | ae(v) |
| ... | |
| } | |
| } | |
| } | |
| } | |
| } | |

TABLE 9
Example PH RBSP semantics

7.4.3.6 Picture header RBSP semantics
...
MaxNumMergeCand = 6 − pic_six_minus_max_num_merge_cand (85)
The value of MaxNumMergeCand shall be in the range of 1 to 6, inclusive. When not present, the
value of pic_six_minus_max_num_merge_cand is inferred to be equal to
pps_six_minus_max_num_merge_cand_plus1 − 1.
...
When pic_five_minus_max_num_triangle_cand is not present, and sps_triangle_enabled_flag is
equal to 1, pic_ five_minus_max_num_triangle_cand is inferred to be equal to
pps_five_cand_minus_max_num_triangle_cand_plus1 − 1.
The maximum number of triangular merge mode candidates, MaxNumTriangleMergeCand is derived
as follows:
MaxNumTriangleMergeCand =
5 − pic_five_minus_max_num_triangle_cand (87)
When pic_six _minus_max_num_triangle_cand is present, the value of MaxNumTriangleMergeCand
shall be in the range of 2 to 6, inclusive.
When MaxNumTriangleMergeCand is equal to 0, triangle merge mode is not allowed for the slices
associated with the PH.
...

As shown, the maximum number of merge candidates for a triangle partition mode may be coded independently. The maximum number of merge candidates for a triangle partition mode may range from a certain value to the other value (for example, from 2 to 5).

Geometric (for example, GEO) prediction mode may be an extension of TPM. Geometric merge mode (GEO) may be used to code a block. GEO may be an inter prediction tool. In GEO, the split may be in one or more angles and/or displacements of the partition boundary relative to the middle of the considered block. In a GEO prediction mode, triangles in TPM may be replaced by wedges. The examples described herein may be used in a GEO prediction mode by replacing (for example, in the syntax and/or semantics) the word triangle with wedge. For example, the maximum number of merge candidates for a GEO mode may be coded independently from the maximum number of merge candidates of the regular merge. The maximum number of merge candidates for GEO may be determined based on an indication in the PPS, the PH and/or in the SPS, or the like. The indication that indicates the maximum number of merge candidates for GEO may be or may include pic_five_minus_max_num_geo_cand, for example.

AMVR may be controlled at a certain level (for example, a SPS level). A SPS syntax may include two or more enablement indicators associated with a video sequence. Example SPS syntax is shown in Table 10. For example, a SPS syntax may include two or more SPS flags as shown in Table 10. As shown in Table 10, the SPS syntax may include an AMVR enablement indicator sps_amvr_enabled_flag and/or an affine mode enablement indicator sps_affine_enabled_flag.

TABLE 10
Example SPS syntax

| | Descriptor |
|---|---|
| seq_parameter_set_rbsp( ) { | |
| ... | |
| sps_amvr_enabled_flag | u(1) |
| ... | |
| sps_affine_enabled_flag | u(1) |
| if( sps_affine_enabled_flag ) { | |
| ... | |
| sps_affine_amvr_enabled_flag | u(1) |
| ... | |
| } | |
| ... | |
| } | |

A first SPS indicator (for example, an AMVR enablement indicator sps_amvr_enabled_flag) may control AMVR for regular CU(s), including an IBC mode. A second SPS indicator (for example, an affine mode AMVR enablement indicator sps_affine_amvr_enabled_flag) may control AMVR for affine modes (for example, only). Table 11 shows an example specification of AmvrShift. The precision of one or more (for example, each) of regular, affine mode, and IBC mode may be different as shown in Table 11.

TABLE 11
Example specification of AmvrShift

| | | AmvrShift | | |
|---|---|---|---|---|
| | | | | inter_affine_flag = =0 |
| | | | | && |
| | | inter_affine_flag = = | CuPredMode[ chType ][ x0 ][ y0 | CuPredMode[ chType ][ x0 ][ y0 |
| amvr_flag | amvr_precision_idx | 1 | ] = = MODE_IBC ) | ] != MODE_IBC |
| 0 | — | 2 (¼ luma sample) | — | 2 (¼ luma sample) |
| 1 | 0 | 0 ( 1/16 luma sample) | 4 (1 luma sample) | 3 (½ luma sample) |
| 1 | 1 | 4 (1 luma sample) | 6 (4 luma samples) | 4 (1 luma sample) |
| 1 | 2 | — | — | 6 (4 luma samples) |

An AMVR precision index (for example, amvr_precision_idx) may be either 0 or 1 for affine mode and/or IBC. The AMVR precision index may be 0, 1, or 2 for regular mode. Semantics of the AMVR precision index may change, for example, based on the mode. The three AMVR modes (for example, associated with regular mode, affine mode, and IBC mode) may differ and, for example, completely different in some examples. Three SPS indicators (for example, one flag for each AMVR mode) may be provided.

An IBC AMVR enablement indicator (for example, SPS IBC AMVR enablement indicator) may be signaled/received for IBC AMVR. The IBC AMVR enablement indicator may be SPS_ibc_amvr_enabled_flag. A SPS syntax may include the IBC AMVR enablement indicator SPS_ibc_amvr_enabled_flag. An affine AMVR enablement indicator (for example, SPS affine AMVR enablement indicator) may control an affine AMVR combination. The affine AMVR enablement indicator may be sps_affine_amvr_enabled_flag. The affine AMVR enablement indicator may indicate whether a combination of affine mode and AMVR is enabled for a video sequence. A parameter set (for example, a SPS) may be associated with the video sequence. Example SPS syntax (for example, for IBC AMVR) is shown in Table 12. The IBC AMVR enablement indicator may be signaled/received to control an IBC AMVR combination as shown in Table 12. The IBC AMVR enablement indicator may indicate whether a combination of IBC and AMVR is enabled for a video sequence. Table 13 shows an example coding unit syntax (for example, for IBC AMVR). Table 14 shows an example SPS RBSP semantics (for example, for IBC AMVR).

The decoder may determine whether to enable IBC AMVR combination (for example, using adaptive motion vector difference resolution in motion vector coding of IBC mode) based on the IBC AMVR enablement indication.

TABLE 12
Example SPS syntax for IBC AMVR

| | Descriptor |
|---|---|
| seq_parameter_set_rbsp( ) { | |
| ... | |
| sps_amvr_enabled_flag | u(1) |
| ... | |
| sps_affine_enabled_flag | u(1) |
| if( sps_affine_enabled_flag ) { | |
| ... | |
| sps_affine_amvr_enabled_flag | u(1) |
| ... | |
| } | |
| sps_ibc_enabled_flag | u(1) |
| if(sps_ibc_enabled_flag) { | |
| sps_ibc_amvr_enabled_flag | u(1) |
| } | |
| ... | |

TABLE 13
Example coding unit syntax for IBC AMVR

| | Descriptor |
|---|---|
| coding_unit( x0, y0, cbWidth, cbHeight, cqtDepth, treeType, modeType ) { | |
| ... | |
| if( CuPredMode[ chType ][ x0 ][ y0 ] = = MODE_INTRA \| \| | |
| CuPredMode[ chType ][ x0 ][ y0 ] = = MODE_PLT ) { | |
| ... | |
| } else if( treeType != DUAL_TREE_CHROMA ) { /* MODE_INTER or MODE_IBC */ | |
| ... | |
| if( general_merge_flag[ x0 ][ y0 ] ) | |
| ... | |
| else if( CuPredMode[ chType ][ x0 ][ y0 ] = = MODE_IBC ) { | |
| ... | ae(v) |
| if( sps_ibc_amvr_enabled_flag && | |
| ( MvdL0[ x0 ][ y0 ][ 0 ] != 0 \| \| MvdL0[ x0 ][ y0 ][ 1 ] | |
| != 0 ) ) | |
| amvr_precision_idx[ x0 ][ y0 ] | ae(v) |
| } else { | |
| ... | |
| } | |

TABLE 14
Example SPS RBSP semantics for IBC AMVR

7.4.3.3 Sequence parameter set RBSP semantics
...
sps_ibc_enabled_flag equal to 1 specifies that the IBC prediction mode may be used in decoding
of pictures in the CLVS. sps_ibc_enabled_flag equal to 0 specifies that the IBC prediction mode is
not used in the CLVS. When sps_ibc_enabled_flag is not present, it is inferred to be equal to 0.
sps_ibc_amvr_enabled_flag equal to 1 specifies that adaptive motion vector difference resolution
is used in motion vector coding of intra-block copy mode. sps_ibc_amvr_enabled_flag equal to 0
specifies that adaptive motion vector difference resolution is not used in motion vector coding of
intra-block copy mode. When not present, the value of sps_ibc_amvr_enabled_flag is inferred to be
equal to 0
...

The combination of IBC and AMVR may be allowed on the condition that AMVR is allowed, for example, at the SPS level. The combination of affine mode and AMVR may be allowed on the condition that AMVR is allowed, for example, at the SPS level. Allowing the combination of IBC and AMVR, or the combination of affine mode and AMVR when AMVR is allowed at the SPS level may reduce the number of possible combinations. For example, an encoder may perform AMVR with one or more of IBC, regular mode or affine mode. An encoder may determine whether AMVR mode and affine mode are enabled for a video sequence and determine whether to include an indicator for affine mode AMVR in a parameter set associated with the video sequence (for example, the SPS shown in the example in Table 15 or Table 16). An encoder may disable AMVR with IBC, regular mode, and affine mode. AMVR may be switched off, for example, if AMVR is available to be switched off, for particular modes (for example, regular mode AMVR, affine mode AMVR, and IBC AMVR) and not the other way around. For example, AMVR may be switched off (for example, disabled) without disabling IBC, regular mode or affine mode.

Example SPS syntax for IBC AMVR combination and affine AMVR combination are shown in Table 15 and Table 16. Table 15 shows an example SPS syntax (for example, for AMVR combination with affine mode). Table 16 shows an example SPS syntax (for example, for AMVR combination with affine mode and/or for AMVR combination with IBC). Table 15 or Table 16 shows an example indicator for a combination of affine mode and AMVR. As shown in Table 15 and Table 16, whether to receive the affine mode AMVR enablement indicator may be determined based on whether AMVR is enabled. For example, as shown in Table 15, if affine mode is enabled for a video sequence and AMVR is enabled for the video sequence as indicated by a value of the AMVR enablement indicator sps_amvr_enabled_flag, the affine mode AMVR enablement indicator may be present in the SPS (for example, shown in Table 15 or Table 16) and received. If AMVR is disabled for a video sequence as indicated by a value of the AMVR enablement indicator sps_amvr_enabled_flag, the affine mode AMVR enablement indicator may be absent from the SPS associated with the video sequence and not received. In examples, the value of affine mode AMVR enablement indicator sps_affine_amvr_enabled_flag may be determined based on whether AMVR is enabled. A value of the affine mode AMVR enablement indicator sps_affine_amvr_enabled_flag may be inferred to be a value indicative of disabling AMVR for the video sequence with the affine mode enabled, on a condition that the affine mode AMVR enablement indicator is not present in the SPS associated with the video sequence.

As shown in Table 15 and Table 16, in addition to the AMVR enablement indicator, whether to receive the affine mode AMVR enablement indicator may be determined based on whether affine mode is enabled. As shown in Table 15 and Table 16, the SPS syntax may include an affine mode enablement indicator sps_affine_enabled_flag. As shown in Table 15 and Table 16, whether the affine mode AMVR enablement indicator may be present in the SPS shown in Table 15 or Table 16 may be based on a value of the affine mode enablement indicator and a value of the AMVR enablement indicator sps_amvr_enabled_flag. For example, as shown in Table 15 and Table 16, if affine mode is enabled for a video sequence as indicated by the affine mode enablement indicator and AMVR is enabled for the video sequence as indicated by a value of the AMVR enablement indicator, the affine mode AMVR enablement indicator may be present in the SPS shown in Table 15 or Table 16. If affine mode is disabled for a video sequence as indicated by the affine mode enablement indicator, the affine mode AMVR enablement indicator may not be present in the SPS shown in Table 15 or Table 16.

As shown in Table 16, whether to receive the IBC AMVR enablement indicator (for example, sps_ibc_amvr_enabled_flag) may be determined based on whether AMVR is enabled (for example, the value of the sps_amvr_enabled_flag). In some examples, if AMVR is enabled in general, AMVR may be disabled for affine via the affine AMVR enablement indicator and/or for IBC mode via the IBC AMVR enablement indicator.

TABLE 15
Example SPS syntax for AMVR combination
(for example, with affine mode)

| | Descriptor |
|---|---|
| seq_parameter_set_rbsp( ) { | |
| ... | |
| sps_amvr_enabled_flag | u(1) |
| ... | |
| sps_affine_enabled_flag | u(1) |
| if( sps_affine_enabled_flag ) { | |
| ... | |
| if (sps_amvr_enabled_flag){ | |
| sps_affine_amvr_enabled_flag | u(1) |
| } | |
| ... | |
| } | |
| ... | |

TABLE 16
Example SPS syntax for AMVR combination

| | De- |
|---|---|
| | scrip- |
| | tor |
| seq_parameter_set_rbsp( ) { | |
| ... | |
| sps_amvr_enabled_flag | u(1) |
| ... | |
| sps_affine_enabled_flag | u(1) |
| if( sps_affine_enabled_flag ) { | |
| ... | |
| if (sps_amvr_enabled_flag){ | |
| sps_affine_amvr_enabled_flag | u(1) |
| } | |
| ... | |
| } | |
| sps_ibc_enabled_flag | u(1) |
| if(sps_ibc_enabled_flag && sps_amvr_enabled_flag) { | |
| sps_ibc_amvr_enabled_flag | u(1) |
| } | |
| ... | |

In examples, a SPS syntax may not include an affine mode AMVR enablement indicator (for example, an affine AMVR SPS flag). If AMVR is disabled for a video sequence as indicated by a value of the AMVR enablement indicator sps_amvr_enabled_flag, an encoder may determine to exclude the affine mode AMVR enablement indicator sps_affine_amvr_enabled_flag from the SPS associated with the video sequence.

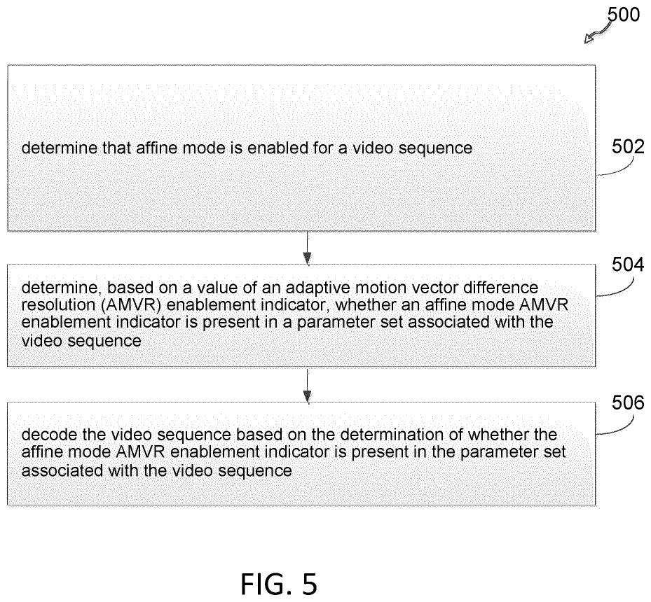

FIG. 5 illustrates an example of a method for determining whether an affine mode AMVR enablement indicator is present in a parameter set, for example, as shown in Tables 15-16. Examples disclosed herein and other examples may operate in accordance with example method 500. Method 500 comprises 502, 504 and 506. Method 500 may be used to process a video. At 502, it may be determined that affine mode is enabled for a video sequence. At 504, whether an affine mode AMVR enablement indicator is present in a parameter set associated with the video sequence may be determined based on a value of an AMVR enablement indicator. At 506, the video sequence may be decoded based on the determination of whether the affine mode AMVR enablement indicator is present in the parameter set associated with the video sequence.

Upon determining that affine mode is enabled for a video sequence, whether to include an affine mode AMVR enablement indicator in a parameter set associated with the video sequence may be determined based on whether AMVR is enabled. The parameter set associated with the video sequence may be generated based on the determination of whether to include the affine mode AMVR enablement indicator in the parameter set.

Method 500 may be performed by an apparatus. The apparatus may include one or more processors. The operations related to the example illustrated in FIG. 5 may be shared by multiple processors or performed by one processor.

In some examples, an affine mode AMVR enablement indicator sps_affine_amvr_enabled_flag may not be signaled/received in SPS(s), for example, as shown in Table 17. Table 17 shows an example SPS syntax (for example, for AMVR). An AMVR enablement indicator (for example, sps_amvr_enabled_flag) may be signaled to enable or disable AMVR. An example SPS syntax for AMVR with no affine AMVR SPS flag is shown in Table 17. As shown in Table 17, a parameter set (for example, an SPS) associated with a video sequence may not include an affine mode AMVR enablement indicator sps_affine_amvr_enabled_flag, for example, regardless of a value of an AMVR enablement indicator and regardless of a value of an affine mode enablement indicator. An example coding unit syntax (for example, for AMVR with no affine AMVR SPS flag) is shown in Table 18.

TABLE 17
Example SPS syntax

| | Descriptor |
|---|---|
| seq_parameter_set_rbsp( ) { | |
| ... | |
| sps_amvr_enabled_flag | u(1) |
| ... | |
| sps_affine_enabled_flag | u(1) |
| if( sps_affine_enabled_flag ) { | |
| ... | |
| ... | |
| } | |
| ... | |
| } | |

TABLE 18
Example coding unit syntax

| | Descriptor |
|---|---|
| coding_unit( x0, y0, cbWidth, cbHeight, cqtDepth, treeType, modeType ) { | |
| ... | |
| if( CuPredMode[ chType ][ x0 ][ y0 ] = = MODE_INTRA \| \| | |
| CuPredMode[ chType ][ x0 ][ y0 ] = = MODE_PLT ) { | |
| ... | |
| } else if( treeType != DUAL_TREE_CHROMA ) { /* MODE_INTER or MODE_IBC */ | |
| ... | |
| if( general_merge_flag[ x0 ][ y0 ] ) | |
| merge_data( x0, y0, cbWidth, cbHeight, chType ) | |
| else if( CuPredMode[ chType ][ x0 ][ y0 ] = = MODE_IBC ) { | |
| ... | |
| } else { | |
| ... | |
| if( sps_affine_enabled_flag && cbWidth >= 16 && cbHeight >= | |
| 16 ) { | |
| inter_affine_flag[ x0 ][ y0 ] | ae(v) |
| if( sps_affine_type_flag && inter_affine_flag[ x0 ][ y0 ] ) | |
| cu_affine_type_flag[ x0 ][ y0 ] | ae(v) |
| } | |
| if( sps_smvd_enabled_flag && !mvd_l1_zero_flag && | |
| inter_pred_idc[ x0 ][ y0 ] = = PRED_BI && | |
| !inter_affine_flag[ x0 ][ y0 ] && RefldxSymL0 > −1 | |
| && RefIdxSymL1 > −1 ) | |
| sym_mvd_flag[ x0 ][ y0 ] | ae(v) |
| ... | |
| if( ( sps_amvr_enabled_flag && inter_affine_flag[ x0 ][ y0 ] = = 0 | |
| && | |
| ( MvdL0[ x0 ][ y0 ][ 0 ] != 0 \| \| MvdL0[ x0 ][ y0 ][ 1 ] != 0 | |
| \| \| | |
| MvdL1[ x0 ][ y0 ][ 0 ] != 0 \| \| MvdL1[ x0 ][ y0 ][ 1 ] != 0 ) | |
| ) \| \| | |
| (sps_amvr_enabled_flag && inter_affine_flag[ x0 ][ y0 ] | |
| = = 1 && | |
| ( MvdCpL0[ x0 ][ y0 ][ 0 ][ 0 ] != 0 \| \| | |
| MvdCpL0[ x0 ][ y0 ][ 0 ][ 1 ] != 0 \| \| | |
| MvdCpL1[ x0 ][ y0 ][ 0 ][ 0 ] != 0 \| \| | |
| MvdCpL1[ x0 ][ y0 ][ 0 ][ 1 ] != 0 \| \| | |
| MvdCpL0[ x0 ][ y0 ][ 1 ][ 0 ] != 0 \| \| | |
| MvdCpL0[ x0 ][ y0 ][ 1 ][ 1 ] != 0 \| \| | |
| MvdCpL1[ x0 ][ y0 ][ 1 ][ 0 ] != 0 \| \| | |
| MvdCpL1[ x0 ][ y0 ][ 1 ][ 1 ] != 0 \| \| | |
| MvdCpL0[ x0 ][ y0 ][ 2 ][ 0 ] != 0 \| \| | |
| MvdCpL0[ x0 ][ y0 ][ 2 ][ 1 ] != 0 \| \| | |
| MvdCpL1[ x0 ][ y0 ][ 2 ][ 0 ] != 0 \| \| | |
| MvdCpL1[ x0 ][ y0 ][ 2 ][ 1 ] != 0 ) ) { | |
| amvr_flag[ x0 ][ y0 ] | ae(v) |
| ... | |
| } | |
| ... | |
| } | |
| } | |
| } | |

TrSkip may be coded at the transform unit (TU) level as shown in Table 19 and 20. Table 19 shows an example coding unit syntax. Table 20 shows an example TU syntax. TrSkip may be coded at the CU level. For example, the CU level syntax may include a TrSkip indicator (for example, transform_skip_flag). MTS and LFNST may be coded at the CU level as shown in Table 19 and 20.

TABLE 19
Example coding unit syntax

| | Descriptor |
|---|---|
| coding_unit( x0, y0, cbWidth, cbHeight, cqtDepth, treeType, modeType ) { | |
| ... | |
| if( cu_cbf ) { | |
| ... | |
| if( Min( lfnstWidth, IfnstHeight ) >= 4 && sps_lfnst_enabled_flag = = 1 | |
| && | |
| CuPredMode[ chType ][ x0 ][ y0 ] = = MODE_INTRA && | |
| transform_skip_flag[ x0 ][ y0 ][ 0 ] = = 0 && | |
| ( treeType = = DUAL_TREE_CHROMA \| \| | |
| !intra_mip_flag[ x0 ][ y0 ] \| \| | |
| Min( lfnstWidth, lfnstHeight ) >= 16 ) && | |
| Max( cbWidth, cbHeight ) <= MaxTbSizeY) { | |
| if( ( IntraSubPartitionsSplitType != ISP_NO_SPLIT \| \| LfnstDcOnly | |
| = = 0 ) && | |
| LfnstZeroOutSigCoeffFlag = = 1 ) | |
| lfnst_idx | ae(v) |
| if( treeType != DUAL_TREE_CHROMA && lfnst_idx = = 0 && | |
| transform_skip_flag[ x0 ][ y0 ][ 0 ] = = 0 && Max( cbWidth, | |
| cbHeight ) <= 32 && | |
| IntraSubPartitionsSplit[ x0 ][ y0 ] = = ISP_NO_SPLIT && | |
| cu_sbt_flag = = 0 && | |
| MtsZeroOutSigCoeffFlag = = 1 && tu_cbf_luma[ x0 ][ y0 ] ) { | |
| if( ( ( CuPredMode[ chType ][ x0 ][y0 ] = = MODE_INTER && | |
| sps_explicit_mts_inter_enabled_flag ) \| \| | |
| ( CuPredMode[ chType ][ x0 ][ y0 ] = = MODE_INTRA && | |
| sps_explicit_mts_intra_enabled_flag ) ) ) | |
| mts_idx | ae(v) |
| } | |
| } | |

TABLE 20
Example TU syntax

| | Descriptor |
|---|---|
| transform_unit( x0, y0, tbWidth, tbHeight, treeType, subTuIndex, chType ) { | |
| ... | |
| if( tu_cbf_cb[ xC ][ yC ] && treeType != DUAL_TREE_LUMA ) { | |
| if( sps_transform_skip_enabled_flag && !BdpcmFlag[ x0 ][ y0 ][ 1 ] && | |
| wC <= MaxTsSize && hC <= MaxTsSize && !cu_sbt_flag ] ) | |
| transform_skip_flag[ xC ][ yC ][ 1 ] | ae(v) |
| ... | |
| } | |
| if( tu_cbf_cr[ xC ][ yC ] && treeType != DUAL_TREE_LUMA && | |
| !( tu_cbf_cb[ xC ][ yC ] && tu_joint_cbcr_residual_flag[ xC ][ yC ] ) ] ) { | |
| if( sps_transform_skip_enabled_flag && !BdpcmFlag[ x0 ][ y0 ][ 2 ] && | |
| wC <= MaxTsSize && hC <= MaxTsSize && !cu_sbt_flag ) | |
| transform_skip_flag[ xC ][ yC ][ 2 ] | ae(v) |
| ... | |
| } | |
| } | |

When TrSkip is coded at the TU level, in some examples, the transform tools (for example, TrSkip, MTS, and LFNST) may not be decoded at the same level. Table 21 shows an example CU syntax. In examples, a TrSkip indicator (for example, transform_skip_flag) may be signaled/received at the CU level, as shown in Table 21 (for example, to improve readability and applicability).

TABLE 21
Example CU syntax

| | Descriptor |
|---|---|
| coding_unit( x0, y0, cbWidth, cbHeight, cqtDepth, treeType, modeType ) { | |
| ... | |
| if( cu_cbf ) { | |
| ... | |
| if( tu_cbf_cb[ xC ][ yC ] && treeType != DUAL_TREE_LUMA ) { | |
| if( sps_transform_skip_enabled_flag && !BdpcmFlag[ x0 ][ y0 ][ 1 ] && | |
| wC <= MaxTsSize && hC <= MaxTsSize && !cu_sbt_flag ] ) | |
| transform_skip_flag[ xC ][ yC ][ 1 ] | ae(v) |
| } | |
| if( tu_cbf_cr[ xC ][ yC ] && treeType != DUAL_TREE_LUMA && | |
| !( tu_cbf_cb[ xC ][ yC ] && tu_joint_cbcr_residual_flag[ xC ][ yC ] ) ] ) { | |
| if( sps_transform_skip_enabled_flag && !BdpcmFlag[ x0 ][ y0 ][ 2 ] && | |
| wC <= MaxTsSize && hC <= MaxTsSize && !cu_sbt_flag ) | |
| transform_skip_flag[ xC ][ yC ][ 2 ] | ae(v) |
| } | |
| transform_tree( x0, y0, cbWidth, cbHeight, treeType, chType ) | |
| lfnstWidth = ( treeType = = DUAL_TREE_CHROMA | |
| ) ? cbWidth / SubWidthC : | |
| (( | |
| IntraSubPartitionsSplitType = = ISP_VER_SPLIT ) ? | |
| cbWidth / | |
| NumIntraSubPartitions : cbWidth ) | |
| lfnstHeight = ( treeType = = DUAL_TREE_CHROMA | |
| ) ? cbHeight / SubHeightC : | |
| (( | |
| IntraSubPartitionsSplitType = = ISP_HOR_SPLIT) ? | |
| cbHeight / | |
| NumIntraSubPartitions : cbHeight ) | |
| if( Min( lfnstWidth, lfnstHeight ) >= 4 && sps_lfnst_enabled_flag = = 1 | |
| && | |
| CuPredMode[ chType ][ x0 ][ y0 ] = = MODE_INTRA && | |
| transform_skip_flag[ x0 ][ y0 ][ 0 ] = = 0 && | |
| ( treeType = = DUAL_TREE_CHROMA \| \| | |
| !intra_mip_flag[ x0 ][ y0 ] \| \| | |
| Min( lfnstWidth, lfnstHeight ) >= 16 ) && | |
| Max( cbWidth, cbHeight ) <= MaxTbSizeY) { | |
| if( ( IntraSubPartitionsSplitType != ISP_NO_SPLIT \| \| LfnstDcOnly | |
| = = 0 ) && | |
| LfnstZeroOutSigCoeffFlag = = 1 ) | |
| lfnst_idx | ae(v) |
| if( treeType != DUAL_TREE_CHROMA && lfnst_idx = = 0 && | |
| transform_skip_flag[ x0 ][ y0 ][ 0 ] = = 0 && Max( cbWidth, | |
| cbHeight) <= 32 && | |
| IntraSubPartitionsSplit[ x0 ][ y0 ] = = ISP_NO_SPLIT && | |
| cu_sbt_flag = = 0 && | |
| MtsZeroOutSigCoeffFlag = = 1 && tu_cbf_luma[ x0 ][ y0 ] ) { | |
| if( ( ( CuPredMode[ chType ][ x0 ][ y0 ] = = MODE_INTER && | |
| sps_explicit_mts_inter_enabled_flag ) \| \| | |
| ( CuPredMode[ chType ][ x0 ][ y0 ] = = MODE_INTRA && | |
| sps_explicit_mts_intra_enabled_flag ) ) ) | |
| mts_idx | ae(v) |
| } | |
| } | |

Syntax element transform_skip_flag[x0][y0][cldx] may specify whether a transform is applied to the associated transform block or not. The array indices x0, y0 may specify the location (x0, y0) of the top-left luma sample of the considered transform block relative to the top-left luma sample of the picture. The array index cldx may specify an indicator for the colour component; in examples, it may be equal to 0 for Y, 1 for Cb, and 2 for Cr. A value of transform_skip_flag[x0][y0][cldx] (for example, equal to 1) may indicate or specify that no transform is applied to the associated transform block. Another value of transform_skip_flag[x0][y0][cldx] (for example, equal to 0) may indicate or specify that the determination of whether transform is applied to the associated transform block or not depends on other syntax elements.

Several constraint flags may disable certain tools at different levels of coding. The different levels of coding may include, for example, a profile level. These constraint flags may be included (for example, signaled) at decoder parameters set (DPS), Video Parameters Set (VPS) or Sequence Parameter Set (SPS). Table 22 shows an example constraint indications (for example, flags). The constraint flags may include the constraint flags shown in Table 22. As shown in Table 22, general constraint information (GCI) may include an AMVR constraint indicator no_amvr_constraint_flag.

TABLE 22
Example constraint indications (for example, flags)

| | Descriptor |
|---|---|
| general_constraint_info( ) { | |
| ... | |
| no_amvr_constraint_flag | u(1) |
| ... | |
| no_mts_constraint_flag | u(1) |
| ... | |
| no_transform_skip_constraint_flag | u(1) |
| no_bdpcm_constraint_flag | u(1) |
| ... | |
| } | |

Example constraint flag semantics are shown in Table 23.

TABLE 23
Example constraint flag semantics

```
  7.4.4.2 General constraint information semantics
  ...
  no_amvr_constraint_flag equal to 1 specifies that sps_amvr_enabled_flag shall be equal to 0.
  no_amvr_constraint_flag equal to 0 does not impose such a constraint.
  ...
  no_mts_constraint_flag equal to 1 specifies that sps_mts_enabled_flag shall be equal to 0.
  no_mts_constraint_flag equal to 0 does not impose such a constraint.
  ...
  no_transform_skip_constraint_flag equal to 1 specifies that sps_transfrom_skip_enabled_flag
  shall be equal to 0. no_transform_skip_constraint_flag equal to 0 does not impose such a constraint.
  ...
  no_bdpcm_constraint_flag equal to 1 specifies that sps_bdpcm_enabled_flag shall be equal to 0.
  no_bdpcm_constraint_flag equal to 0 does not impose such a constraint.
...
```

A value of the AMVR constraint indicator may indicate whether AMVR is enabled, for example, at a profile level. In some examples, when a value of no_amvr_constraint_flag indicates AMVR is disabled (for example, is equal to one), sps_amvr_enabled_flag may be set to a value indicative that AMVR is disabled for a video sequence (for example, equal to zero), but sps_affine_amvr_enabled_flag may not be set to a value indicative that AMVR is disabled (for example, equal to zero). In these examples, the no_amvr_constraint_flag may not completely disable AMVR, for example, resulting undefined behaviors of device(s) such as a decoder. In these examples, affine mode AMVR may be active regardless of the value of the no_amvr_constraint_flag. As described in examples herein (for example, as shown in Table 15 and Table 16), whether an affine mode AMVR enablement indicator is present in a parameter set associated with the video sequence may be determined based on whether AMVR is enabled for the video sequence. If AMVR is disabled for the video sequence as indicated by a value of the AMVR enablement indicator sps_amvr_enabled_flag, sps_amvr_enabled_flag may not be present in the parameter set associated with the video sequence. When a value of no_amvr_constraint_flag indicates AMVR is disabled, and thus sps_amvr_enabled_flag is set to a value indicative that AMVR is disabled for a video sequence, sps_amvr_enabled_flag may not be present in the parameter set associated with the video sequence. no_amvr_constraint_flag may completely disable AMVR. Affine mode AMVR may be inactive based on the value of the no_amvr_constraint_flag.

Example constraint flag semantics are shown in Table 24.

TABLE 24
Example constraint flag semantics

7.4.4.2 General constraint information semantics
...
no_amvr_constraint_flag equal to 1 specifies that sps_amvr_enabled_flag and
sps_affine_amvr_enabled_flag shall be equal to 0. no_amvr_constraint_flag equal to 0 does not
impose such a constraint.
...
no_mts_constraint_flag equal to 1 specifies that sps_mts_enabled_flag,
sps_explicit_mts_intra_enabled_flag and sps_explicit_mts_inter_enabled_flag shall be equal to 0.
no_mts_constraint_flag equal to 0 does not impose such a constraint.
...
no_transform_skip_constraint_flag equal to 1 specifies that sps_transfrom_skip_enabled_flag,
sps_bdpcm_enabled_flag and sps_bdpcm_chroma_enabled_flag shall be equal to 0.
no_transform_skip_constraint_flag equal to 0 does not impose such a constraint.
...
no_bdpcm_constraint_flag equal to 1 specifies that sps_bdpcm_enabled_flag and
sps_bdcpm_chroma_enabled_flag shall be equal to 0. no_bdpcm_constraint_flag equal to 0 does
not impose such a constraint.
...

As shown in the example illustrated in Table 24, when a value of no_amvr_constraint_flag indicates AMVR is disabled (for example, is equal to one), sps_amvr_enabled_flag may be set to a value indicative that AMVR is disabled for a video sequence (for example, equal to zero), and sps_affine_amvr_enabled_flag may be set to a value indicative that AMVR is disabled (for example, equal to zero).

As shown in the example illustrated in Table 24, when no_mts_constraint_flag is equal to one, sps_mts_enabled_flag may be equal to zero, sps_explicit_mts_intra_enabled_flag may be equal to zero, and sps_explicit_mts_inter_enabled_flag may be equal to zero.

As shown in the example illustrated in Table 24, when no_transform_skip_constraint_flag is equal to one, sps_transform_skip_enabled_flag may be equal to zero, sps_bdpcm_enabled_flag may be equal to zero, and sps_bdpcm_chroma_enabled_flag may be equal to zero.

As shown in the example illustrated in Table 24, when no_bdpcm_constraint_flag is equal to one, sps_bdpcm_enabled_flag may be equal to zero, and sps_bdpcm_chroma_enabled_flag may be equal to zero.

Adaptive motion vector resolution (AMVR) may be used. Motion vector differences (MVDs) between a first motion vector (for example, a motion vector of a CU) and a second motion vector (for example, a predicted motion vector of the CU) may be signaled in units of quarter-luma-sample when an indication (for example, use_integer_mv_flag) is equal to a certain value (for example, 0) in a slice header. The value may indicate whether MVDs are signaled. The value may indicate whether MVDs are signaled in integer-sample precisions. CU-level AMVR may be used to process (for example, code) CUs. Using AMVR may allow one or more MVDs of a CU to be coded in different precisions. Depending on a mode (for example, a normal AMVR mode or an affine AMVR mode) for a current CU, one or more MVDs (precision) for the current CU may be adaptively selected. For example, a first MVD precision (for example, of quarter-luma-sample, half-luma-sample, integer-luma-sample, or four-luma-sample) may be selected for a current CU in a normal AMVR mode. A second MVD precision (for example, of quarter-luma-sample, integer-luma-sample, or 1/16 luma-sample) may be selected for a current CU in an affine AMVR mode.

A CU-level MVD resolution indication may be signaled, for example if the current CU has one or more non-zero MVD components. If the MVD components (for example, horizontal and vertical MVDs for reference lists L0 and L1) are zero, the MVD precision (for example, a MVD resolution) may be determined (for example, inferred) to be, for example, quarter-luma-sample.

For a CU that has one or more non-zero MVD components, an indication (for example, a first flag) may be signaled that indicates whether a quarter-luma-sample MVD precision is used for the CU. If the indication (for example, the first flag) has a value that indicates that a quarter-luma-sample MVD precision is used for the CU (for example, 0), a quarter-luma-sample MVD precision may be used for the CU and further signaling may be skipped. If the indication (for example, the first flag) has a value that indicates that a quarter-luma-sample MVD precision is not used for the CU (for example, 1), an indication (for example, a second flag) may be signaled to indicate whether a half-luma-sample MVD precision is used for the AMVR CU. If the indication (for example, the second flag) indicates that a half-luma-sample MVD precision is used for the AMVR CU, a 6-tap interpolation filter may be used (for example, instead of an 8-tap interpolation filter that may be a default) for the half-luma sample position. If the indication (for example, the second flag) indicates that a half-luma-sample MVD precision is not used for the AMVR CU, an indication (for example, a third flag) may be signaled to indicate whether a four-luma-sample or integer-luma-sample MVD precision is used for the AMVR CU.

For an affine AMVR CU, an indication (for example, the second flag) may be used to indicate whether an integer-luma-sample or 1/16 luma-sample MVD precision is used. One or more motion vector predictors for the CU may be rounded to the same precision as that of the MVD (for example, before being added to the MVD), for example, such that the reconstructed MV has the intended precision (for example, quarter-luma-sample, half-luma-sample, integer-luma-sample, or four-luma-sample). The motion vector predictors may be rounded towards zero (for example, a negative motion vector may be rounded toward positive infinity and a positive motion vector predictor may be rounded toward negative infinity).

A video processing device may determine a motion vector precision (for example, a motion vector resolution) for the current CU, for example using an RD check. The video processing device may include an encoder. RD checks for one or more MVD precisions (for example, other than a quarter-luma-sample MVD precision) may be skipped in some examples and invoked in other examples (for example, conditionally). For a normal AMVR mode, an RD cost of a quarter-luma-sample MVD precision and/or an integer-luma-sample MV precision may be obtained (for example, computed). The RD cost of the integer-luma-sample MVD precision may be compared to that of the quarter-luma-sample MVD precision, for example, to determine whether to further check the RD cost of a four-luma-sample MVD precision. If the RD cost for quarter-luma-sample MVD precision is smaller than that of the integer-luma-sample MVD precision (for example, by a certain value), an RD check for four-luma-sample MVD precision may be skipped. For example, the RD check for the four-luma-sample MVD precision may be skipped if a ratio of the RD cost of the inter-luma-sample MVD prediction to the RD cost of the quarter-luma-sample MVD precision is in the range of approximately 1.04-1.1 (for example, 1.06). A check of half-luma-sample MVD precision may be skipped if the RD cost of integer-luma-sample MVD precision is (for example, significantly) larger than the best RD cost of previously-tested MVD precisions. For example, the check of the half-luma-sample MVD precision may be skipped if a ratio of the RD cost of the integer-luma sample to the best RD cost is in the range of approximately 1.2-1.3 (for example, 1.25). For an affine AMVR mode, if an affine inter mode is not selected after checking rate-distortion costs of an affine merge/skip mode, a merge/skip mode, a quarter-luma-sample MVD precision AMVR mode and/or a quarter-luma-sample MVD precision affine AMVR mode, 1/16 luma-sample MV precision and/or 1-pel MV precision affine inter modes may not be checked. One or more affine parameters obtained in a quarter-luma-sample MV precision affine inter mode may be used as a starting search point in 1/16 luma-sample and/or quarter-luma-sample MV precision affine inter modes.

Affine motion compensation may be used as an inter-coding tool. Implementations using an affine mode may be described herein. A translation motion model may be applied for motion-compensated prediction. There may be many kinds of motion (for example, zoom in or out, rotation, perspective motions, and/or other irregular motions). A simplified affine transform motion-compensated prediction may be applied. A flag for inter-coded CUs (for example, each inter-coded CU) may be signaled, for example, to indicate whether a translation motion or affine motion model is applied for inter prediction. A flag may be signaled (for example, if affine motion is used) to indicate the number of parameters used in an affine motion model (for example, four or six).

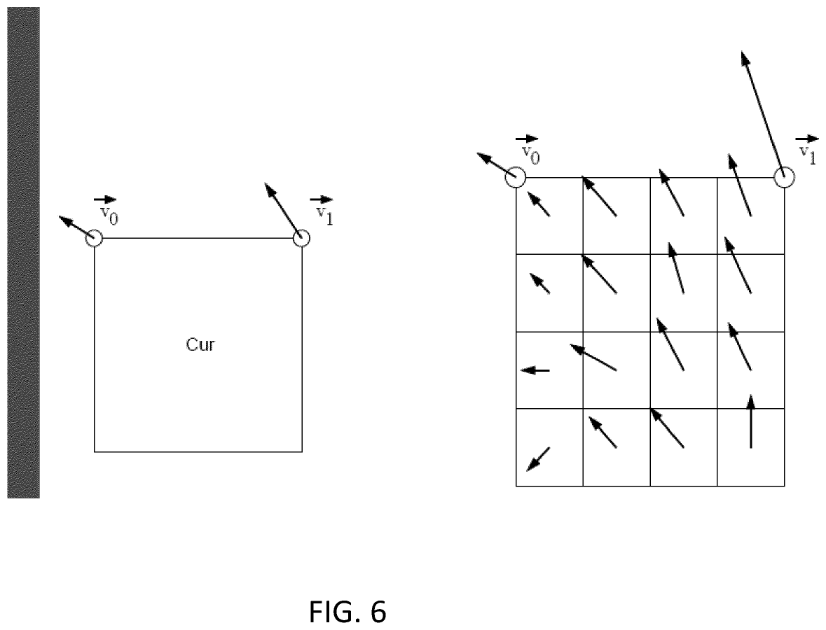

An affine motion model may be a four-parameter model. Two parameters may be used for translation movement (for example, one for each of the horizontal and vertical directions). One parameter may be used for zoom motion. One parameter may be used for rotation motion. A horizontal zoom parameter may be equal to a vertical zoom parameter. A horizontal rotation parameter may be equal to a vertical rotation parameter. A four-parameter motion model may be coded using two motion vectors (MVs) as a (for example, one) pair at two control point positions defined at the top-left corner and top-right corner of a current CU. FIG. 6 illustrates an example four parameter affine mode model and sub-block level motion derivation for affine blocks. As shown in FIG. 6, an affine motion field of a block may be described by two control point motion vectors (V₀, V₁). Based on control point motion, a motion field (vₓ, v_{y}) may be described, for example, according to Equation 1:

$${v}_{x} = \frac{( {v}_{1 x} - {v}_{0 x} )}{w} x - \frac{( {v}_{1 y} - {v}_{0 y} )}{w} y + {v}_{0 x} {v}_{y} = \frac{( {v}_{1 y} - {v}_{{0}_{y}} )}{w} x + \frac{( {v}_{1 x} - {v}_{0 x} )}{w} y + {v}_{{0}_{y}} \qquad ( 1 )$$

where (v₀ₓ, v_{0y}) may be a motion vector of the top-left corner control point, (v₁ₓ, v_{1y}) may be a motion vector of the top-right corner control point, as shown in FIG. 6, and w may be the width of the CU.

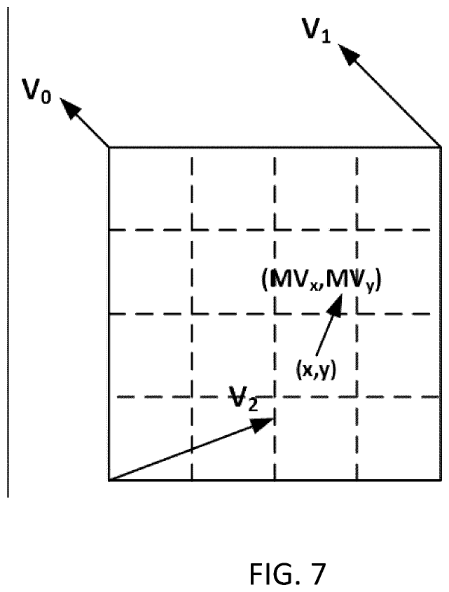

An affine motion model may be a six-parameter model. Two parameters may be used for translation movement (for example, one for each of the horizontal and vertical directions). Two parameters may be used for zoom motion (for example, one for each of the horizontal and vertical directions). Two parameters may be used for rotation motion (for example, one for each of the horizontal and vertical directions). The six-parameter motion model may be coded with three MVs at three control points. FIG. 7 illustrates an example six parameter affine mode where V₀, V₁, and V₂ are control points and (MVₓ, MV_{y}) is a motion vector of a sub-block centered at position (x, y). As shown in FIG. 7, the control points for a six-parameter affine coded CU may be defined at the top left, top right, and bottom left corners of the CU. The motion at the top left control point may be related to translation motion. The motion at the top right control point may be related to rotation and zoom motion in the horizontal direction. The motion at the bottom left control point may be related to rotation and zoom motion in the vertical direction. The rotation and zoom motion in the horizontal direction may be different from the motion in the vertical direction. The MV of a sub-block (for example, each sub-block) (vₓ, v_{y}) may be derived using three MVs at control points, for example, according to Equations 2 and 3:

$${v}_{x} = {v}_{0 x} + ( {v}_{1 x} - {v}_{0 x} ) * \frac{x}{w} + ( {v}_{2 x} - {v}_{0 x} ) * \frac{y}{h} \qquad ( 2 )$$

$${v}_{y} = {v}_{0 y} + ( {v}_{1 y} - {v}_{0 y} ) * \frac{x}{w} + ( {v}_{2 y} - {v}_{0 y} ) * \frac{y}{h} \qquad ( 3 )$$

where (v₂ₓ, v_{2y}) may be the motion vector of the bottom-left control point, (x, y) may be the center position of the sub-block, and w and h may be the width and height of the CU, respectively.

A motion field for a block coded with an affine motion model may be derived based on, for example, the granularity of a sub-block. An MV of a (for example, each) sub-block may be derived, for example, by calculating a MV of the center sample of the sub-block (for example, as shown in FIG. 6) (for example, according to Eq. (1)). A calculation may be rounded, for example, to 1/16-pel accuracy. The derived MVs may be used at the motion compensation stage to generate a prediction signal of the sub-block (for example, each sub-block) inside the current block. The sub-block size applied for affine motion compensation may be, for example, 4×4. The four parameters of the 4-parameter affine model may be estimated, for example, iteratively. For example, one or more MV pairs at step k may be denoted as {(v₀ₓ^{k}, v_{0y}^{k}), (v₁ₓ^{k}, v_{1y}^{k})}. An original luminance signal may be denoted as I(i, j). A prediction luminance signal may be denoted as I′ₖ(i, j). Spatial gradients gₓ(i, j) and g_{y}(i, j) may be derived, for example, with a Sobel filter applied on the prediction signal I′ₖ(i, j) in the horizontal and vertical directions, respectively. The derivative of Equation (1) may be represented, for example, according to Equation 4:

$$\{ \begin{matrix}{dv}_{x}^{k} ( x , y ) = c ⋆ x - d ⋆ y + a \\ {dv}_{y}^{k} ( x , y ) = d ⋆ x + c ⋆ y + b\end{matrix} \qquad ( 4 )$$

where (a, b) may be delta translation parameters, and (c, d) may be delta zoom and rotation parameters at step k. The delta MV at control points may be derived with coordinates, for example, according to Equations 5 and 6. For example, (0, 0) and (w, 0) may be coordinates for the top-left and top-right control points, respectively.

$$\{ \begin{matrix}d {v}_{0 x}^{k} = {v}_{0 x}^{k + 1} - {v}_{0 x}^{k} = a \\ d {v}_{0 y}^{k} = {v}_{0 y}^{k + 1} - {v}_{0 y}^{k} = b\end{matrix} \qquad ( 5 )$$

$$\{ \begin{matrix}d {v}_{1 x}^{k} = ( {v}_{1 x}^{k + 1} - {v}_{1 x}^{k} ) = c * w + a \\ d {v}_{1 y}^{k} = ( {v}_{1 y}^{k + 1} - {v}_{1 y}^{k} ) = d * w + b\end{matrix} \qquad ( 6 )$$

The relationship between the change of luminance and the spatial gradient and temporal movement may be formulated, for example, according to Equation 7:

I′ₖ(i,j)−I(i,j)=gₓ(i,j)*dvₓ^{k}(i,j)+g_{y}(i,j)*d_{y}^{k}(i,j) (7)

where dvₓ^{k}(i,j) and dv_{y}^{k}(i, j) may be substituted with the values in Equation (4), for example, to obtain an equation for parameters (a, b, c, d), for example, as shown in Equation 8:

I′ₖ(i,j)−I(i,j)=(gₓ(i,j)*i+g_{y}(i,j)*j)*c+(−gₓ(i,j)*j+g_{y}(i,j)*i)*d+gₓ(i,j)*a+g_{y}(i,j)*b (8)

The parameter set (a, b, c, d) may be derived, for example, using the least square method (for example, since the samples in the CU satisfy Equation 8). The MVs at the control points {(v₀ₓ^{k+1}, v_{0y}^{k+1}), (v₁ₓ^{k+1}, v_{1y}^{k+1})} at step (k+1) may be solved with Equations 5 and 6, and they may be rounded to a specific precision (for example, ¼ pel). The MVs at two control points may be refined (for example, using iteration) until parameters (a, b, c, d) are (for example, all) zero or the number of times the iteration has been performed reaches a (for example, pre-defined) limit.

The six parameters of a six-parameter affine model may be estimated. Equation 4 may be changed, for example, according to Equation 9:

$$\{ \begin{matrix}d {v}_{x}^{k} ( x , y ) = c * x + d * y + a \\ d {v}_{y}^{k} ( x , y ) = e * x + f * y + b\end{matrix} \qquad ( 9 )$$

where (a, b) may be delta translation parameters, (c, d) may be delta zoom and rotation parameters for the horizontal direction, and (e, f) may be delta zoom and rotation parameters for the vertical direction, at step k. Equation 8 may be changed, for example, according to Eq. 10:

I′ₖ(i,j)−I(i,j)=(gₓ(i,j)*i)*c+(gₓ(i,j)*j)*d+(g_{y}(i,j)*i)*e+(g_{y}(i,j)*j)*f+gₓ(i,j)*a+g_{y}(i,j)*b (10)

The parameter set (a, b, c, d, e, f) may be derived, for example, using a least square method, for example, by considering a sample (for example, the samples) within a CU. The MV of the top left control point (v₀ₓ^{k+1}, v_{0y}^{k+1}) may be calculated using Equation 5. The MV of the top right control point (v₁ₓ^{k+1}, v_{1y}^{k+1}) and the MV of the bottom left control point (v₂ₓ^{k+1}, v_{2y}^{k+1}) may be calculated, for example, according to Equations 11 and 12:

$$\{ \begin{matrix}d {v}_{1 x}^{k} = ( {v}_{1 x}^{k + 1} - {v}_{1 x}^{k} ) = c * w + a \\ d {v}_{1 y}^{k} = ( {v}_{1 y}^{k + 1} - {v}_{1 y}^{k} ) = e * w + b\end{matrix} \qquad ( 11 )$$

$$\{ \begin{matrix}d {v}_{2 x}^{k} = ( {v}_{2 x}^{k + 1} - {v}_{2 x}^{k} ) = d * h + a \\ d {v}_{2 y}^{k} = ( {v}_{2 y}^{k + 1} - {v}_{2 y}^{k} ) = f * h + b\end{matrix} \qquad ( 12 )$$

Various implementations herein involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, signaling a check condition in picture header RBSP semantics limiting minimum number of TPM candidates to two, decoupling number of merge candidates in TPM/Geo from regular merge, signaling an SPS flag for IBC AMVR, allowing IBC- and affine-AMVR combination if AMVR is activated, removing an affine AMVR SPS flag, signaling TrSkip at CU level, modifying constraint flag semantics, determining that affine mode is enabled for a video sequence; determining whether an affine mode AMVR enablement indicator is present in a parameter set associated with the video sequence based on the value of an AMVR enablement indicator; decoding the video sequence based on the determination of whether the affine mode AMVR enablement indicator is present in the parameter set associated with the video sequence; if the value of the AMVR enablement indicator indicates AMVR mode is enabled for the video sequence, determining that the affine mode AMVR enablement indicator is present in the parameter set associated with the video sequence; if the value of the AMVR enablement indicator indicates AMVR mode is disabled for the video sequence, determining that the affine mode AMVR enablement indicator is not present in the parameter set associated with the video sequence; obtaining the affine mode AMVR enablement indicator in response to a determination that the affine mode AMVR enablement indicator is present in the parameter set associated with the video sequence; setting a value of the affine mode AMVR enablement indicator to a value indicative of disabling AMVR for the video sequence with the affine mode enabled in response to a determination that the affine mode AMVR enablement indicator is not present in the parameter set associated with the video sequence; setting the value of an AMVR enablement indicator to a value indicative of disabling AMVR for the video sequence based on GCI; determining that the affine mode AMVR enablement indicator is not present in the parameter set associated with the video sequence based on the value of the AMVR enablement indicator indicative of disabling AMVR for the video sequence; determining that the AMVR enablement indicator is in the parameter set associated with the video sequence; determining that the parameter set associated with the video sequence may include a SPS associated with the video sequence; determining that affine mode is enabled for the video sequence based on a value of an affine mode enablement indicator, and determining whether the affine mode AMVR enablement indicator is present in the parameter set based on a value of the affine mode enablement indicator; determining whether a combination of the affine mode and AMVR is enabled for the video sequence based on the affine mode AMVR enablement indicator; if the affine mode AMVR enablement indicator indicates enabling AMVR for the video sequence with the affine mode enabled, adaptively determining a precision of a motion vector difference associated with a coding block of the video sequence based on a coding mode associated with the coding block; determining that IBC is enabled for the video sequence, obtaining an IBC AMVR enablement indicator in response to the determination that IBC is enabled for the video sequence, and decoding the video sequence based on the IBC AMVR enablement indicator.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining that affine mode is enabled for a video sequence; determining whether to include an affine mode AMVR enablement indicator in a parameter set associated with the video sequence based on the value of an AMVR enablement indicator; generating the parameter set associated with the video sequence based on the determination of whether to include the affine mode AMVR enablement indicator in the parameter set associated with the video sequence; if the value of the AMVR enablement indicator indicates AMVR mode is enabled for the video sequence, determining to include the affine mode AMVR enablement indicator in the parameter set associated with the video sequence; if the value of the AMVR enablement indicator indicates AMVR mode is disabled for the video sequence, determining not to include the affine mode AMVR enablement indicator in the parameter set associated with the video sequence; generating the parameter set associated with the video sequence, including the AMVR enablement indicator; generating a parameter set associated with the video sequence without the affine mode AMVR enablement indicator in response to a determination not to include the affine mode AMVR enablement indicator in the parameter set associated with the video sequence; including the AMVR enablement indicator in the parameter set associated with the video sequence; determining that the parameter set associated with the video sequence may be a SPS associated with the video sequence; determining whether affine mode is enabled for the video sequence based on a value of an affine mode enablement indicator; determining whether to include the affine mode AMVR enablement indicator in the parameter set based on the determination of whether affine mode is enabled for the video sequence; determining whether a combination of the affine mode and AMVR is enabled for the video sequence based on the affine mode AMVR enablement indicator; determining that IBC is enabled for the video sequence, determining to include an IBC AMVR enablement indicator in a parameter set associated with the video sequence in response to the determination that IBC is enabled for the video sequence, and generating the parameter set that includes the IBC AMVR enablement indicator.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, for example, sps_amvr_enabled_flag, sps_affine_enabled_flag, sps_affine_amvr_enabled_flag, sps_ibc_amvr_enabled_flag, sps_ibc_enabled_flag, MaxNumMergeCand, pps_five_cand_minus_max_num_triangle_cand_plus1, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular IBC AMVR flag in SPS, an AMVR enablement indicator, an affine mode AMVR enablement indicator, GCI constraints, an affine mode enablement indicator, or an IBC AMVR enablement indicator etc. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types.

A decoder may perform method 500 as described in FIG. 5. FIG. 5 illustrates an example of a method for determining whether an affine mode AMVR enablement indicator is present in a parameter set, for example, as shown in Tables 15-16. For example, a decoder may determine that affine mode is enabled for a video sequence. The decoder may determine whether an affine mode AMVR enablement indicator is present in a parameter set associated with the video sequence based on the value of an AMVR enablement indicator. The decoder may decode the video sequence based on the determination of whether the affine mode AMVR enablement indicator is present in the parameter set associated with the video sequence. If the value of the AMVR enablement indicator indicates AMVR mode is enabled for the video sequence, the decoder may determine that the affine mode AMVR enablement indicator is present in the parameter set associated with the video sequence. If the value of the AMVR enablement indicator indicates AMVR mode is disabled for the video sequence, the decoder may determine that the affine mode AMVR enablement indicator is not present in the parameter set associated with the video sequence. In examples, the decoder may obtain the affine mode AMVR enablement indicator in response to a determination that the affine mode AMVR enablement indicator is present in the parameter set associated with the video sequence. In examples, the decoder may set a value of the affine mode AMVR enablement indicator to a value indicative of disabling AMVR for the video sequence with the affine mode enabled in response to a determination that the affine mode AMVR enablement indicator is not present in the parameter set associated with the video sequence. The decoder may set the value of the AMVR enablement indicator to a value indicative of disabling AMVR for the video sequence based on GCI. The decoder may determine that the affine mode AMVR enablement indicator is not present in the parameter set associated with the video sequence based on the value of the AMVR enablement indicator indicative of disabling AMVR for the video sequence. The AMVR enablement indicator may be in the parameter set associated with the video sequence. The parameter set associated with the video sequence may include a SPS associated with the video sequence. The decoder may determine that affine mode is enabled for the video sequence based on a value of an affine mode enablement indicator, and the determination of whether the affine mode AMVR enablement indicator is present in the parameter set may be in response to the determination that affine mode is enabled for the video sequence based on the value of the affine mode enablement indicator. The affine mode AMVR enablement indicator may indicate whether a combination of the affine mode and AMVR is enabled for the video sequence. In response to the affine mode AMVR enablement indicator indicating enabling AMVR for the video sequence with the affine mode enabled, the decoder may adaptively determine a precision of a motion vector difference associated with a coding block of the video sequence based on a coding mode associated with the coding block. The decoder may determine that IBC is enabled for the video sequence, obtain an IBC AMVR enablement indicator in response to the determination that IBC is enabled for the video sequence, and decode the video sequence based on the IBC AMVR enablement indicator.

Decoding tools and techniques including one or more of entropy decoding, inverse quantization, inverse transformation, and differential decoding may be used to enable the method as described in FIG. 5 in the decoder. These decoding tools and techniques may be used to enable one or more of determining that affine mode is enabled for a video sequence; determining whether an affine mode AMVR enablement indicator is present in a parameter set associated with the video sequence based on the value of an AMVR enablement indicator; decoding the video sequence based on the determination of whether the affine mode AMVR enablement indicator is present in the parameter set associated with the video sequence; if the value of the AMVR enablement indicator indicates AMVR mode is enabled for the video sequence, determining that the affine mode AMVR enablement indicator is present in the parameter set associated with the video sequence; if the value of the AMVR enablement indicator indicates AMVR mode is disabled for the video sequence, determining that the affine mode AMVR enablement indicator is not present in the parameter set associated with the video sequence; obtaining the affine mode AMVR enablement indicator in response to a determination that the affine mode AMVR enablement indicator is present in the parameter set associated with the video sequence; setting a value of the affine mode AMVR enablement indicator to a value indicative of disabling AMVR for the video sequence with the affine mode enabled in response to a determination that the affine mode AMVR enablement indicator is not present in the parameter set associated with the video sequence; setting the value of the AMVR enablement indicator to a value indicative of disabling AMVR for the video sequence based on GCI; determining that the affine mode AMVR enablement indicator is not present in the parameter set associated with the video sequence based on the value of the AMVR enablement indicator indicative of disabling AMVR for the video sequence; determining that the AMVR enablement indicator is in the parameter set associated with the video sequence; determining that the parameter set associated with the video sequence may include a SPS associated with the video sequence; determining that affine mode is enabled for the video sequence based on a value of an affine mode enablement indicator, and determining whether the affine mode AMVR enablement indicator is present in the parameter set based on a value of the affine mode enablement indicator; determining whether a combination of the affine mode and AMVR is enabled for the video sequence based on the affine mode AMVR enablement indicator; if the affine mode AMVR enablement indicator indicates enabling AMVR for the video sequence with the affine mode enabled, adaptively determining a precision of a motion vector difference associated with a coding block of the video sequence based on a coding mode associated with the coding block; determining that IBC is enabled for the video sequence, obtaining an IBC AMVR enablement indicator in response to the determination that IBC is enabled for the video sequence, and decoding the video sequence based on the IBC AMVR enablement indicator; and other decoder behaviors that are related to any of the above.

An encoder may determine that affine mode is enabled for a video sequence. The encoder may determine whether to include an affine mode AMVR enablement indicator in a parameter set associated with the video sequence based on the value of an AMVR enablement indicator. The encoder may generate the parameter set associated with the video sequence based on the determination of whether to include the affine mode AMVR enablement indicator in the parameter set associated with the video sequence. If the value of the AMVR enablement indicator indicates AMVR mode is enabled for the video sequence, the encoder may determine to include the affine mode AMVR enablement indicator in the parameter set associated with the video sequence. If the value of the AMVR enablement indicator indicates AMVR mode is disabled for the video sequence, the encoder may determine not to include the affine mode AMVR enablement indicator in the parameter set associated with the video sequence. In examples, the encoder may generate the parameter set associated with the video sequence, including the AMVR enablement indicator. In examples, the encoder may generate a parameter set without the affine mode AMVR enablement indicator in response to a determination not to include the affine mode AMVR enablement indicator in the parameter set associated with the video sequence. The AMVR enablement indicator may be in the parameter set associated with the video sequence. The parameter set associated with the video sequence may include a SPS associated with the video sequence. The encoder may determine whether affine mode is enabled for the video sequence based on a value of an affine mode enablement indicator, and the determination of whether to include the affine mode AMVR enablement indicator in the parameter set may be based on the determination of whether affine mode is enabled for the video sequence. The affine mode AMVR enablement indicator may indicate whether a combination of the affine mode and AMVR is enabled for the video sequence. The encoder may determine that IBC is enabled for the video sequence, determine to include an IBC AMVR enablement indicator in a parameter set associated with the video sequence in response to the determination that IBC is enabled for the video sequence, and generate the parameter set that includes the IBC AMVR enablement indicator.

Encoding tools and techniques including one or more of quantization, entropy coding, inverse quantization, inverse transformation, and differential coding may be used to enable the method as described herein in the encoder. These encoding tools and techniques may be used to enable one or more of determining that affine mode is enabled for a video sequence; determining whether to include an affine mode AMVR enablement indicator in a parameter set associated with the video sequence based on the value of an AMVR enablement indicator; generating the parameter set associated with the video sequence based on the determination of whether to include the affine mode AMVR enablement indicator in the parameter set associated with the video sequence; if the value of the AMVR enablement indicator indicates AMVR mode is enabled for the video sequence, determining to include the affine mode AMVR enablement indicator in the parameter set associated with the video sequence; if the value of the AMVR enablement indicator indicates AMVR mode is disabled for the video sequence, determining not to include the affine mode AMVR enablement indicator in the parameter set associated with the video sequence; generating the parameter set associated with the video sequence, including the AMVR enablement indicator; generating a parameter set associated with the video sequence without the affine mode AMVR enablement indicator in response to a determination not to include the affine mode AMVR enablement indicator in the parameter set associated with the video sequence; including the AMVR enablement indicator in the parameter set associated with the video sequence; determining that the parameter set associated with the video sequence may be a SPS associated with the video sequence; determining whether affine mode is enabled for the video sequence based on a value of an affine mode enablement indicator; determining whether to include the affine mode AMVR enablement indicator in the parameter set based on the determination of whether affine mode is enabled for the video sequence; determining whether a combination of the affine mode and AMVR is enabled for the video sequence based on the affine mode AMVR enablement indicator; determining that IBC is enabled for the video sequence, determining to include an IBC AMVR enablement indicator in a parameter set associated with the video sequence in response to the determination that IBC is enabled for the video sequence, and generating the parameter set that includes the IBC AMVR enablement indicator; and other encoder behaviors that are related to any of the above.

A syntax element(s) may be inserted in the signaling, for example, to enable the decoder to identify an indication associated with performing the method as described in FIG. 5, or the method to use. For example, the syntax element may include one or more of an AMVR enablement indicator, an affine mode AMVR enablement indicator, GCI constraints, an affine mode enablement indicator, or an IBC AMVR enablement indicator etc. As an example, the decoder may determine whether a combination of the affine mode and AMVR is enabled for a video sequence based on a value of an affine mode AMVR enablement indicator. The method as described in FIG. 5 may be selected and/or applied, for example, based on the syntax element(s) to apply at the decoder. For example, the decoder may receive an AMVR enablement indicator and determine whether an affine mode AMVR enablement indicator is present in a parameter set associated with the video sequence based on a value of the AMVR enablement indicator.

The encoder may adapt prediction residual based on one or more examples herein. A residual may be obtained, for example, by subtracting a predicted video block from the original image block. For example, the encoder may predict a video block based on a value of an AMVR enablement indicator as described herein. The encoder may obtain the original image block and subtract the predicted video block from the original image block to generate a prediction residual.

A bitstream or signal may include one or more of the described syntax elements, or variations thereof. For example, a bitstream or signal may include a syntax element(s) for any of one or more of an AMVR enablement indicator, an affine mode AMVR enablement indicator, GCI constraints, an affine mode enablement indicator, or an IBC AMVR enablement indicator etc.

A bitstream or signal may include syntax conveying information generated according to one or more examples herein. For example, information or data may be generated in performing the example as described herein. The generated information or data may be conveyed in syntax included in the bitstream or signal.

Syntax elements that enable the decoder to adapt a residue(s) in a manner corresponding to that used by an encoder may be inserted in a signal. For example, the residual may be generated using one or more examples herein.

A method, process, apparatus, medium storing instructions, medium storing data, or signal for creating and/or transmitting and/or receiving and/or decoding a bitstream or signal that includes one or more of the described syntax elements, or variations thereof.

A method, process, apparatus, medium storing instructions, medium storing data, or signal for creating and/or transmitting and/or receiving and/or decoding according to any of the examples described.

A method, process, apparatus, medium storing instructions, medium storing data, or signal according to, but not limited to one or more of the following: determining whether affine mode is enabled for a video sequence; obtaining an affine mode enablement indicator; determining whether affine mode is enabled for a video sequence based on an affine mode enablement indicator; determining whether affine mode is enabled for a video sequence based on an affine mode enablement indicator that is included in a parameter set; determining whether AMVR mode is enabled for a video sequence based on an AMVR enablement indicator that is included in a parameter set; obtaining an AMVR enablement indicator; determining whether AMVR mode is enabled for a video sequence based on an AMVR enablement indicator; determining whether AMVR mode is enabled for a video sequence based on an AMVR enablement indicator that is included in a parameter set; determining whether an affine mode AMVR enablement indicator is present in a parameter set associated with the video sequence based on the value of an AMVR enablement indicator; decoding the video sequence based on the determination of whether the affine mode AMVR enablement indicator is present in the parameter set associated with the video sequence; if the value of the AMVR enablement indicator indicates AMVR mode is enabled for the video sequence, determining that the affine mode AMVR enablement indicator is present in the parameter set associated with the video sequence; if the value of the AMVR enablement indicator indicates AMVR mode is disabled for the video sequence, determining that the affine mode AMVR enablement indicator is not present in the parameter set associated with the video sequence; obtaining the affine mode AMVR enablement indicator in response to a determination that the affine mode AMVR enablement indicator is present in the parameter set associated with the video sequence; setting a value of the affine mode AMVR enablement indicator to a value indicative of disabling AMVR for the video sequence with the affine mode enabled in response to a determination that the affine mode AMVR enablement indicator is not present in the parameter set associated with the video sequence; setting the value of the AMVR enablement indicator to a value indicative of disabling AMVR for the video sequence based on GCI; determining that the affine mode AMVR enablement indicator is not present in the parameter set associated with the video sequence based on the value of the AMVR enablement indicator indicative of disabling AMVR for the video sequence; determining that the AMVR enablement indicator is in the parameter set associated with the video sequence; determining that the parameter set associated with the video sequence may include a SPS associated with the video sequence; determining that affine mode is enabled for the video sequence based on a value of an affine mode enablement indicator, and determining whether the affine mode AMVR enablement indicator is present in the parameter set based on a value of the affine mode enablement indicator; determining whether a combination of the affine mode and AMVR is enabled for the video sequence based on the affine mode AMVR enablement indicator; in response to the affine mode AMVR enablement indicator indicating enabling AMVR for the video sequence with the affine mode enabled, adaptively determining a precision of a motion vector difference associated with a coding block of the video sequence based on a coding mode associated with the coding block; determining that IBC is enabled for the video sequence, obtaining an IBC AMVR enablement indicator in response to the determination that IBC is enabled for the video sequence, and decoding the video sequence based on the IBC AMVR enablement indicator.

A TV, set-top box, cell phone, tablet, or other electronic device may determine whether an affine mode AMVR enablement indicator is present in a parameter set associated with a video sequence according to any of the examples described.

A TV, set-top box, cell phone, tablet, or other electronic device may determine whether an affine mode AMVR enablement indicator is present in a parameter set associated with a video sequence according to any of the examples described, and display (for example using a monitor, screen, or other type of display) a resulting image.

A TV, set-top box, cell phone, tablet, or other electronic device may select (for example using a tuner) a channel to receive a signal including an encoded image, and determine whether an affine mode AMVR enablement indicator is present in a parameter set associated with a video sequence according to any of the examples described.

A TV, set-top box, cell phone, tablet, or other electronic device may receive (for example using an antenna) a signal over the air that includes an encoded image, and determine whether an affine mode AMVR enablement indicator is present in a parameter set associated with a video sequence according to any of the examples described.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A video decoding apparatus, comprising one or more processors, wherein the one or more processors are configured to:
determine that affine mode is enabled for a video sequence;
determine, based on a value of an adaptive motion vector difference resolution (AMVR) enablement indicator, whether an affine mode AMVR enablement indicator is present in a parameter set associated with the video sequence; and
decode the video sequence based on the determination of whether the affine mode AMVR enablement indicator is present in the parameter set associated with the video sequence.

2. The video decoding apparatus of claim 1, wherein the one or more processors are configured to, on a condition that the value of the AMVR enablement indicator indicates AMVR mode is enabled for the video sequence, determine that the affine mode AMVR enablement indicator is present in the parameter set associated with the video sequence, and on a condition that the value of the AMVR enablement indicator indicates AMVR mode is disabled for the video sequence, determine that the affine mode AMVR enablement indicator is not present in the parameter set associated with the video sequence.

3. (canceled)

4. The video decoding apparatus of claim 1, wherein the one or more processors are configured to obtain the affine mode AMVR enablement indicator in response to a determination that the affine mode AMVR enablement indicator is present in the parameter set associated with the video sequence.

5. The video decoding apparatus of claim 1, wherein the one or more processors are configured to set a value of the affine mode AMVR enablement indicator to a value indicative of disabling AMVR for the video sequence with the affine mode enabled in response to a determination that the affine mode AMVR enablement indicator is not present in the parameter set associated with the video sequence.

6. The video decoding apparatus of claim 1, wherein the one or more processors are further configured to:
set the value of the AMVR enablement indicator to a value indicative of disabling AMVR for the video sequence based on general constraint information (GCI); and
determine that the affine mode AMVR enablement indicator is not present in the parameter set associated with the video sequence based on the value of the AMVR enablement indicator indicative of disabling AMVR for the video sequence.

7. The video decoding apparatus of claim 1, wherein the one or more processors are further configured to:
determine that intra-block copy (IBC) is enabled for the video sequence; and
obtain an IBC AMVR enablement indicator in response to the determination that IBC is enabled for the video sequence, wherein the video sequence is decoded based on the IBC AMVR enablement indicator.

8. The video decoding apparatus of claim 1, wherein the one or more processors are further configured to:
based on a value of the affine mode AMVR enablement indicator indicative of enabling AMVR for the video sequence with the affine mode enabled, adaptively determine a precision of a motion vector difference associated with a coding block of the video sequence based on a coding mode associated with the coding block.

9. (canceled)

10. A video decoding method, comprising:
determining that affine mode is enabled for a video sequence;
determining, based on a value of an adaptive motion vector difference resolution (AMVR) enablement indicator, whether an affine mode AMVR enablement indicator is present in a parameter set associated with the video sequence; and
decoding the video sequence based on the determination of whether the affine mode AMVR enablement indicator is present in the parameter set associated with the video sequence.

11. The video decoding method of claim 10, further comprising, on a condition that the value of the AMVR enablement indicator indicates AMVR is enabled for the video sequence, determining that the affine mode AMVR enablement indicator is present in the parameter set associated with the video sequence, and, on a condition that the value of the AMVR enablement indicator indicates AMVR is disabled for the video sequence, determining that the affine mode AMVR enablement indicator is not present in the parameter set associated with the video sequence.

12. (canceled)

13. (canceled)

14. The video decoding method of claim 10, further comprising setting a value of the affine mode AMVR enablement indicator to a value indicative of disabling AMVR for the video sequence with the affine mode enabled in response to a determination that the affine mode AMVR enablement indicator is not present in the parameter set associated with the video sequence.

15. The video decoding method of claim 10, further comprising:
setting the value of the AMVR enablement indicator to a value indicative of disabling AMVR for the video sequence based on general constraint information (GCI); and
determining that the affine mode AMVR enablement indicator is not present in the parameter set associated with the video sequence based on the value of the AMVR enablement indicator indicative of disabling AMVR for the video sequence.

16. The video decoding method of claim 10, further comprising:
determining that intra-block copy (IBC) is enabled for the video sequence; and
obtaining an affine mode IBC enablement indicator in response to the determination that IBC is enabled for the video sequence, wherein the video sequence is decoded based on the affine mode IBC enablement indicator.

17.-21. (canceled)

22. The video decoding method of claim 10, wherein the parameter set associated with the video sequence comprises a SPS associated with the video sequence.

23. (canceled)

24. A computer readable medium including instructions for causing one or more processors to perform the video decoding method of claim 10.

25.-30. (canceled)

31. A video encoding apparatus, comprising one or more processors, wherein the one or more processors are configured to:
determine that an affine mode is enabled for a video sequence;
determine, based on a value of an adaptive motion vector difference resolution (AMVR) enablement indicator, whether to include an affine mode AMVR enablement indicator in a parameter set associated with the video sequence; and
generate the parameter set associated with the video sequence based on the determination of whether to include the affine mode AMVR enablement indicator in the parameter set associated with the video sequence.

32. The video encoding apparatus of claim 31, wherein the one or more processors are further configured to, on a condition that the value of the AMVR enablement indicator indicates AMVR is enabled for the video sequence, determine that the affine mode AMVR enablement indicator is present in the parameter set associated with the video sequence, and, on a condition that the value of the AMVR enablement indicator indicates AMVR is disabled for the video sequence, determine that the affine mode AMVR enablement indicator is not present in the parameter set associated with the video sequence.

33. The video encoding apparatus of claim 31, wherein the one or more processors are further configured to:
determine that intra-block copy (IBC) is enabled for the video sequence; and
obtain an affine mode IBC enablement indicator in response to the determination that IBC is enabled for the video sequence, wherein the video sequence is encoded based on the affine mode IBC enablement indicator.

34. A video encoding method, comprising:
determining that an affine mode is enabled for a video sequence;
determining, based on a value of an adaptive motion vector difference resolution (AMVR) enablement indicator, whether to include an affine mode AMVR enablement indicator in a parameter set associated with the video sequence; and
generating the parameter set associated with the video sequence based on the determination of whether to include the affine mode AMVR enablement indicator in the parameter set associated with the video sequence.

35. The video encoding method of claim 34, further comprising, on a condition that the value of the AMVR enablement indicator indicates AMVR is enabled for the video sequence, determining that the affine mode AMVR enablement indicator is present in the parameter set associated with the video sequence, and, on a condition that the value of the AMVR enablement indicator indicates AMVR is disabled for the video sequence, determining that the affine mode AMVR enablement indicator is not present in the parameter set associated with the video sequence.

36. The video encoding method of claim 34, further comprising:
determining that intra-block copy (IBC) is enabled for the video sequence; and
obtaining an affine mode IBC enablement indicator in response to the determination that IBC is enabled for the video sequence, wherein the video sequence is encoded based on the affine mode IBC enablement indicator.
